(19) United States
(12) Patent Application Publication
(10) Pub. No.: US 2026/0052016 A1
(43) Pub. Date: Feb. 19, 2026

(54) PROVIDING RAPID RECONNECTION BY PERSISTING POINT-TO-POINT CONNECTIONS

(71) Applicant: Citrix Systems, Inc., Fort Lauderdale, FL (US)

(72) Inventors: Sridharan Rajagopalan, Buford, GA (US); Aaroh Ramesh Gala, Pompano Beach, FL (US); Hubert Divoux, Parkland, FL (US); Rakesh Ranjan Jha, San Jose, CA (US); Daniel Wing, Truckee, CA (US)

(21) Appl. No.: 18/807,550

(22) Filed: Aug. 16, 2024

(51) Int. Cl. H04L 9/32; H04L 9/30; H04L 67/146

(52) U.S. Cl. CPC H04L 9/3213; H04L 9/30; H04L 67/146

(57) ABSTRACT

A computing system may receive a request to access a resource from a first device. The computing system may generate a token corresponding to a connection between the first device and a gateway. The computing system updates the token based on information corresponding to a second device hosting the resource. The computing system may establish a connection between the second device and the gateway. The computing system may identify a disconnect between the first device and the gateway. The computing system may maintain a persistent connection between the second device and the gateway. The computing system may use the token to reestablish a connection between the first device and the gateway. The computing system may resume a connection between the second device and the gateway, providing a reconnect between the first device and the second device.

### FIELD

Aspects described herein generally relate to computer networking, remote computer access, virtualization, enterprise mobility management, and hardware and software related thereto. More specifically, one or more aspects described herein provide a method for providing rapid reconnection for disconnected sessions between a client device and virtual applications/desktops by persisting point-to-point connections.

### BACKGROUND

Internet services providing virtual applications and/or desktops (e.g., display remoting/display as a service (DaaS), software as a service (SaaS), or the like) often use one or more proxies between the origination end-point (e.g., a client device, or the like) of a connection and a termination end-point (e.g., a server, or the like). These proxies might serve various purposes (e.g., providing an access gateway, authentication, authorization, audit, and/or other purposes). In such a service architecture, as soon as one of the endpoints loses connectivity, the end-to-end connection (e.g., between a client device and a server hosting virtual applications/desktops) is severed. Accordingly, to provide the services to the client device again, the end-to-end connection to be re-established from scratch.

Establishing or re-establishing an end-to-end connection using conventional methods is inefficient and may negatively impact the user experience. A user of a client device may experience significant delays as the client device attempts to reconnect to a server because of the need to reestablish multiple point-to-point connections. For example, in the context of reestablishing a connection for a remote display protocol like the Independent Computing Architecture protocol (ICA) (e.g., developed by Citrix Systems, Inc. of Ft. Lauderdale, Florida) the need to reestablish multiple point-to-point connections directly impacts the end-user experience as the user waits for the connection to be reestablished with the server to use a remote desktop or a remote published application.

### SUMMARY

The following presents a simplified summary of various aspects described herein. This summary is not an extensive overview, and is not intended to identify required or critical elements or to delineate the scope of the claims. The following summary merely presents some concepts in a simplified form as an introductory prelude to the more detailed description provided below.

To overcome limitations in the prior art described above, and to overcome other limitations that will be apparent upon reading and understanding the present specification, aspects described herein are directed towards providing rapid reconnection by persisting point-to-point connections.

In one or more instances, a computing system may include one or more processors and memory storing computer executable instructions that, when executed by the processors cause the computing system to receive, from a first device, a resource request. The computing system may generate, based on user authentication information, a reconnect token for initiating a reconnect between the first device and a second device. The computing system may update, based on information of a connection between the second device and the gateway, the reconnect token. The computing system may identify, based on one or more trigger parameters, a disconnect between the first device and the gateway. The computing system may pause the connection between the second device and the gateway. The computing system may reestablish, based on the reconnect token, the connection between the first device and the gateway. The computing system may resume, based on reestablishing the connection between the first device and the gateway, the connection between the second device and the gateway.

In one or more examples, a reconnect token may comprise an identifier corresponding to the indicator of the reconnect token, an indicator of a resource corresponding to the resource request, identification information corresponding to the first device and to the second device, an indicator of a validity period for the reconnect token, and/or other information. In one or more arrangements, the computing system may store, at a secure authentication component separate from the first device, the reconnect token. The computing system may generate, based on storing the reconnect token, a secure authentication identifier for the reconnect token. In these arrangements, reestablishing the connection between the first device and the gateway may comprise retrieving, from the secure authentication component and based on the secure authentication identifier, the reconnect token.

In one or more examples, reestablishing the connection between the first device and the gateway may comprise reconstructing, based on the indicator of the reconnect token, the session file. Reestablishing the connection between the first device and the gateway may comprise resolving, based on the reconnect token, a domain name corresponding to the gateway. Reestablishing the connection between the first device and the gateway may comprise connecting, based on the indicator of the reconnect token, the first device and the gateway.

In one or more arrangements, the computing system may receive, from the first device, the user authentication information. The user authentication information may comprise a public key. The computing system may store the public key. In these arrangements, reestablishing the connection between the first device and the gateway may comprise authenticating, based on the stored public key, the first device. The computing system may retrieve, based on authenticating the first device, the reconnect token.

In one or more examples, updating the reconnect token may comprise adding, to the reconnect token, a fully-qualified domain name corresponding to the gateway. In one or more arrangements, the gateway may restrict access to a plurality of resources affiliated with the second device. In one or more examples, the computing system may generate, based on the reconnect token, a challenge query for the first device. The computing system may authenticate, based on the challenge query and prior to resuming the connection between the second device and the gateway, the connection between the first device and the gateway.

In one or more arrangements, the computing system may identify a policy change corresponding to the connection between the second device and the gateway. The computing system may invalidate, based on the policy change, the reconnect token. The computing system may establish, based on invalidating the reconnect token, a new connection between the second device and the gateway. In one or more examples, the computing system may identify a policy change corresponding to the connection between the second device and the gateway. The computing system may identify a plurality of additional devices associated with the second device and affected by the policy change. The computing system may update, based on resuming the connection between the gateway and the second device, the plurality of additional devices and the second device.

In one or more arrangements, the computing system may identify a change in a protocol corresponding to the first device. In these arrangements, identifying the disconnect between the first device and the gateway may comprise identifying, based on the change in the protocol corresponding to the first device, a change in an Internet Protocol (IP) address corresponding to the first device. Reestablishing the connection between the first device and the gateway may comprise reestablishing the connection using protocols corresponding to the connection between the first device and the gateway. In one or more examples, the one or more trigger parameters may comprise one or more of: identifying a change in an IP address corresponding to the first device, identifying a change in a protocol corresponding to the connection between the first device and the gateway, and/or identifying a change in a protocol corresponding to the connection between the gateway and the second device.

In one or more arrangements, the computing system may reestablish, based on the reconnect token, one or more additional connections corresponding to the connection between the first device and the second device. The one or more additional connection may comprise at least one of: a connection to a device intermediary to the first device and the gateway, or a connection to a device intermediary to the second device and the gateway. In one or more examples, the computing system may identify, after pausing the connection between the second device and the gateway, whether a license corresponding to the first device and a resource associated with the second device is active. The computing system may resume the connection between the second device and the gateway based on identifying that the license is active.

These and additional aspects will be appreciated with the benefit of the disclosures discussed in further detail below.

### BRIEF DESCRIPTION OF THE DRAWINGS

A more complete understanding of aspects described herein and the advantages thereof may be acquired by referring to the following description in consideration of the accompanying drawings, in which like reference numbers indicate like features, and wherein:

FIG. 1 depicts an illustrative computer system architecture that may be used in accordance with one or more illustrative aspects described herein.

FIG. 2 depicts an illustrative remote-access system architecture that may be used in accordance with one or more illustrative aspects described herein.

FIG. 3 depicts an illustrative virtualized system architecture that may be used in accordance with one or more illustrative aspects described herein.

FIG. 4 depicts an illustrative cloud-based system architecture that may be used in accordance with one or more illustrative aspects described herein.

FIG. 5 depicts an illustrative computing environment for providing rapid reconnection by persisting point-to-point connections in accordance with one or more illustrative aspects described herein.

FIG. 6 depicts an illustrative event sequence for performing an initial launch as part of providing rapid reconnection by persisting point-to-point connections in accordance with one or more illustrative aspects described herein.

FIG. 7 depicts an illustrative event sequence for reestablishing a connection as part of providing rapid reconnection by persisting point-to-point connections in accordance with one or more illustrative aspects described herein.

FIG. 8 depicts an illustrative event sequence for implementing policy changes as part of providing rapid reconnection by persisting point-to-point connections in accordance with one or more illustrative aspects described herein.

FIG. 9 depicts an illustrative event sequence for performing an offline launch in accordance with one or more illustrative aspects as described herein.

FIGS. 10A-10B depict illustrative methods for providing rapid reconnection by persisting point-to-point connections in accordance with one or more illustrative aspects described herein.

### DETAILED DESCRIPTION

In the following description of the various embodiments, reference is made to the accompanying drawings identified above and which form a part hereof, and in which is shown by way of illustration various embodiments in which aspects described herein may be practiced. It is to be understood that other embodiments may be utilized and structural and functional modifications may be made without departing from the scope described herein. Various aspects are capable of other embodiments and of being practiced or being carried out in various different ways.

As a general introduction to the subject matter described in more detail below, aspects described herein are directed towards providing rapid reconnection by persisting point-to-point connections. For example, as is described further below, delays caused by reestablishing an end-to-end connection may be prevented and/or mitigated by maintaining one or more persistent point-to-point connections when one point-to-point connection of the end-to-end connection is disconnected. Whereas current solutions may require reestablishing every point-to-point connection necessary to resume an end-to-end connection interrupted by a severed point-to-point connection, by persisting point-to-point connections the time required to resume the end-to-end connection may be reduced because only the severed point-to-point connection need be reestablished, improving efficiency and the user experience.

Current systems for providing services such as display remoting may require an end-to-end connection, between a client device and a server hosting the service, including at least a point-to-point connection between the client device and a gateway and another point-to-point connection between the gateway and the server. If one of the point-to-point connections is severed (e.g., interrupted, dropped, and/or otherwise disconnected), conventional systems may require reestablishing both point-to-point connections to resume the end-to-end connection. Persistent point-to-point connections (e.g., connections which are not severed and are temporarily paused as described herein) may improve efficiency of resuming end-to-end connections by reducing the number of point-to-point connections that are reestablished, as described above. However, reestablishing the severed point-to-point connection using conventional methods may include inefficient approaches to identifying devices, domain names, and/or interfaces requires to resume the end-to-end connection. As a result, it may be important to further enhance the reconnection process using rapid reconnection features as described herein.

For example, providing rapid reconnection by persisting point-to-point connections as described herein may provide further improvements to efficiency by maintaining information that may be used to increase the speed with which a severed point-to-point connection is reestablished. A reconnect token may be generated while establishing an initial end-to-end connection. The reconnect token may include information (e.g., identifiers of session files for the connection, indicators of resources corresponding to the end-to-end connection, identification information for the connected devices, and/or other information) that may be used to identify the persistent point-to-point connections needed to resume the end-to-end connection. By implementing these reconnect tokens, the methods described herein improve over current methods of resuming end-to-end connections by increasing the speed with which the information needed to resume the connection is identified.

It is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof. The use of the terms “mounted,” “connected,” “coupled,” “positioned,” “engaged” and similar terms, is meant to include both direct and indirect mounting, connecting, coupling, positioning and engaging.

### Computing Architecture

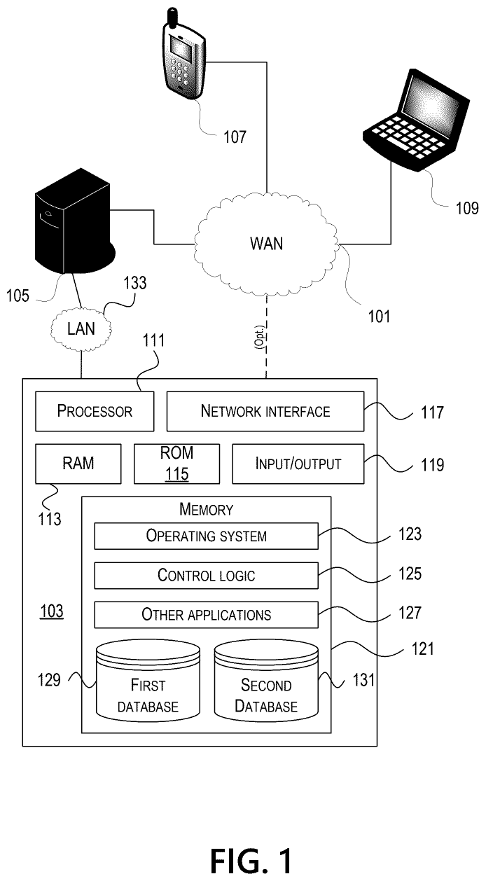

Computer software, hardware, and networks may be utilized in a variety of different system environments, including standalone, networked, remote-access (also known as remote desktop), virtualized, and/or cloud-based environments, among others. FIG. 1 illustrates one example of a system architecture and data processing device that may be used to implement one or more illustrative aspects described herein in a standalone and/or networked environment. Various network nodes 103, 105, 107, and 109 may be interconnected via a wide area network (WAN) 101, such as the Internet. Other networks may also or alternatively be used, including private intranets, corporate networks, local area networks (LAN), metropolitan area networks (MAN), wireless networks, personal networks (PAN), and the like. Network 101 is for illustration purposes and may be replaced with fewer or additional computer networks. A local area network 133 may have one or more of any known LAN topology and may use one or more of a variety of different protocols, such as Ethernet. Devices 103, 105, 107, and 109 and other devices (not shown) may be connected to one or more of the networks via twisted pair wires, coaxial cable, fiber optics, radio waves, or other communication media.

The term “network” as used herein and depicted in the drawings refers not only to systems in which remote storage devices are coupled together via one or more communication paths, but also to stand-alone devices that may be coupled, from time to time, to such systems that have storage capability. Consequently, the term “network” includes not only a “physical network” but also a “content network,” which is comprised of the data—attributable to a single entity—which resides across all physical networks.

The components may include data server 103, web server 105, and client computers 107, 109. Data server 103 provides overall access, control and administration of databases and control software for performing one or more illustrative aspects describe herein. Data server 103 may be connected to web server 105 through which users interact with and obtain data as requested. Alternatively, data server 103 may act as a web server itself and be directly connected to the Internet. Data server 103 may be connected to web server 105 through the local area network 133, the wide area network 101 (e.g., the Internet), via direct or indirect connection, or via some other network. Users may interact with the data server 103 using remote computers 107, 109, e.g., using a web browser to connect to the data server 103 via one or more externally exposed web sites hosted by web server 105. Client computers 107, 109 may be used in concert with data server 103 to access data stored therein, or may be used for other purposes. For example, from client device 107 a user may access web server 105 using an Internet browser, as is known in the art, or by executing a software application that communicates with web server 105 and/or data server 103 over a computer network (such as the Internet).

Servers and applications may be combined on the same physical machines, and retain separate virtual or logical addresses, or may reside on separate physical machines. FIG. 1 illustrates just one example of a network architecture that may be used, and those of skill in the art will appreciate that the specific network architecture and data processing devices used may vary, and are secondary to the functionality that they provide, as further described herein. For example, services provided by web server 105 and data server 103 may be combined on a single server.

Each component 103, 105, 107, 109 may be any type of known computer, server, or data processing device. Data server 103, e.g., may include a processor 111 controlling overall operation of the data server 103. Data server 103 may further include random access memory (RAM) 113, read only memory (ROM) 115, network interface 117, input/output interfaces 119 (e.g., keyboard, mouse, display, printer, etc.), and memory 121. Input/output (I/O) 119 may include a variety of interface units and drives for reading, writing, displaying, and/or printing data or files. Memory 121 may further store operating system software 123 for controlling overall operation of the data processing device 103, control logic 125 for instructing data server 103 to perform aspects described herein, and other application software 127 providing secondary, support, and/or other functionality which may or might not be used in conjunction with aspects described herein. The control logic 125 may also be referred to herein as the data server software 125. Functionality of the data server software 125 may refer to operations or decisions made automatically based on rules coded into the control logic 125, made manually by a user providing input into the system, and/or a combination of automatic processing based on user input (e.g., queries, data updates, etc.).

Memory 121 may also store data used in performance of one or more aspects described herein, including a first database 129 and a second database 131. In some embodiments, the first database 129 may include the second database 131 (e.g., as a separate table, report, etc.). That is, the information can be stored in a single database, or separated into different logical, virtual, or physical databases, depending on system design. Devices 105, 107, and 109 may have similar or different architecture as described with respect to device 103. Those of skill in the art will appreciate that the functionality of data processing device 103 (or device 105, 107, or 109) as described herein may be spread across multiple data processing devices, for example, to distribute processing load across multiple computers, to segregate transactions based on geographic location, user access level, quality of service (QoS), etc.

One or more aspects may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HyperText Markup Language (HTML) or Extensible Markup Language (XML). The computer executable instructions may be stored on a computer readable medium such as a nonvolatile storage device. Any suitable computer readable storage media may be utilized, including hard disks, CD-ROMs, optical storage devices, magnetic storage devices, solid state storage devices, and/or any combination thereof. In addition, various transmission (non-storage) media representing data or events as described herein may be transferred between a source and a destination in the form of electromagnetic waves traveling through signal-conducting media such as metal wires, optical fibers, and/or wireless transmission media (e.g., air and/or space). Various aspects described herein may be embodied as a method, a data processing system, or a computer program product. Therefore, various functionalities may be embodied in whole or in part in software, firmware, and/or hardware or hardware equivalents such as integrated circuits, field programmable gate arrays (FPGA), and the like. Particular data structures may be used to more effectively implement one or more aspects described herein, and such data structures are contemplated within the scope of computer executable instructions and computer-usable data described herein.

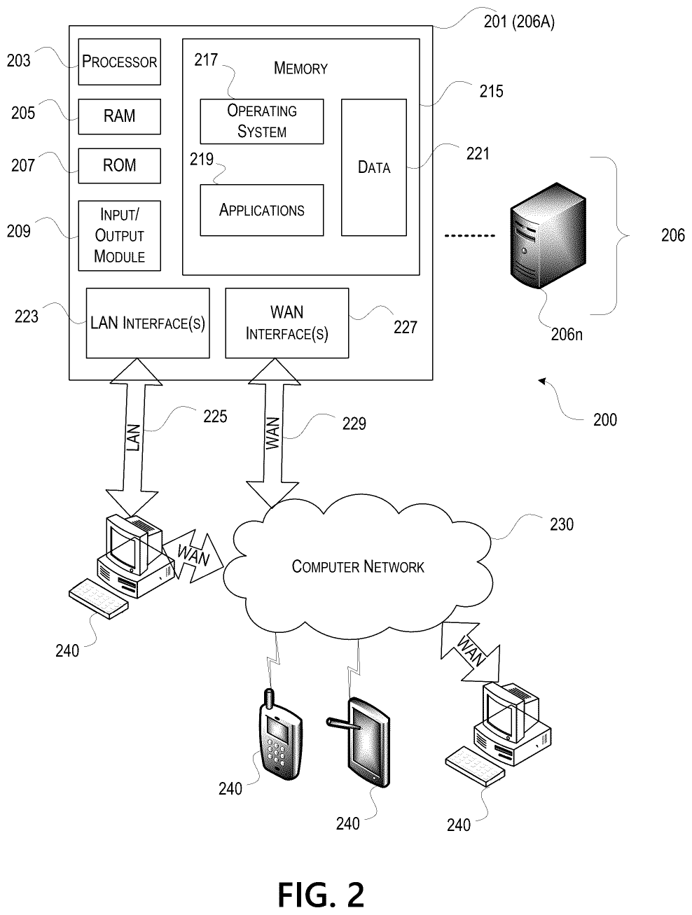

With further reference to FIG. 2, one or more aspects described herein may be implemented in a remote-access environment. FIG. 2 depicts an example system architecture including a computing device 201 in an illustrative computing environment 200 that may be used according to one or more illustrative aspects described herein. Computing device 201 may be used as a server 206a in a single-server or multi-server desktop virtualization system (e.g., a remote access or cloud system) and can be configured to provide virtual machines for client access devices. The computing device 201 may have a processor 203 for controlling overall operation of the device 201 and its associated components, including RAM 205, ROM 207, Input/Output (I/O) module 209, and memory 215.

I/O module 209 may include a mouse, keypad, touch screen, scanner, optical reader, and/or stylus (or other input device(s)) through which a user of computing device 201 may provide input, and may also include one or more of a speaker for providing audio output and one or more of a video display device for providing textual, audiovisual, and/or graphical output. Software may be stored within memory 215 and/or other storage to provide instructions to processor 203 for configuring computing device 201 into a special purpose computing device in order to perform various functions as described herein. For example, memory 215 may store software used by the computing device 201, such as an operating system 217, application programs 219, and an associated database 221.

Computing device 201 may operate in a networked environment supporting connections to one or more remote computers, such as terminals 240 (also referred to as client devices and/or client machines). The terminals 240 may be personal computers, mobile devices, laptop computers, tablets, or servers that include many or all of the elements described above with respect to the computing device 103 or 201. The network connections depicted in FIG. 2 include a local area network (LAN) 225 and a wide area network (WAN) 229, but may also include other networks. When used in a LAN networking environment, computing device 201 may be connected to the LAN 225 through a network interface or adapter 223. When used in a WAN networking environment, computing device 201 may include a modem or other wide area network interface 227 for establishing communications over the WAN 229, such as computer network 230 (e.g., the Internet). It will be appreciated that the network connections shown are illustrative and other means of establishing a communications link between the computers may be used. Computing device 201 and/or terminals 240 may also be mobile terminals (e.g., mobile phones, smartphones, personal digital assistants (PDAs), notebooks, etc.) including various other components, such as a battery, speaker, and antennas (not shown).

Aspects described herein may also be operational with numerous other general purpose or special purpose computing system environments or configurations. Examples of other computing systems, environments, and/or configurations that may be suitable for use with aspects described herein include, but are not limited to, personal computers, server computers, hand-held or laptop devices, multiprocessor systems, microprocessor-based systems, set top boxes, programmable consumer electronics, network personal computers (PCs), minicomputers, mainframe computers, distributed computing environments that include any of the above systems or devices, and the like.

As shown in FIG. 2, one or more client devices 240 may be in communication with one or more servers 206a-206n (generally referred to herein as “server(s) 206”). In one embodiment, the computing environment 200 may include a network appliance installed between the server(s) 206 and client machine(s) 240. The network appliance may manage client/server connections, and in some cases can load balance client connections amongst a plurality of backend servers 206.

The client machine(s) 240 may in some embodiments be referred to as a single client machine 240 or a single group of client machines 240, while server(s) 206 may be referred to as a single server 206 or a single group of servers 206. In one embodiment a single client machine 240 communicates with more than one server 206, while in another embodiment a single server 206 communicates with more than one client machine 240. In yet another embodiment, a single client machine 240 communicates with a single server 206.

A client machine 240 can, in some embodiments, be referenced by any one of the following non-exhaustive terms: client machine(s); client(s); client computer(s); client device(s); client computing device(s); local machine; remote machine; client node(s); endpoint(s); or endpoint node(s). The server 206, in some embodiments, may be referenced by any one of the following non-exhaustive terms: server(s), local machine; remote machine; server farm(s), or host computing device(s).

In one embodiment, the client machine 240 may be a virtual machine. The virtual machine may be any virtual machine, while in some embodiments the virtual machine may be any virtual machine managed by a Type 1 or Type 2 hypervisor, for example, a hypervisor developed by Citrix Systems, IBM, VMware, or any other hypervisor. In some aspects, the virtual machine may be managed by a hypervisor, while in other aspects the virtual machine may be managed by a hypervisor executing on a server 206 or a hypervisor executing on a client 240.

Some embodiments include a client device 240 that displays application output generated by an application remotely executing on a server 206 or other remotely located machine. In these embodiments, the client device 240 may execute a virtual machine receiver program or application to display the output in an application window, a browser, or other output window. In one example, the application is a desktop, while in other examples the application is an application that generates or presents a desktop. A desktop may include a graphical shell providing a user interface for an instance of an operating system in which local and/or remote applications can be integrated. Applications, as used herein, are programs that execute after an instance of an operating system (and, optionally, also the desktop) has been loaded.

The server 206, in some embodiments, uses a remote presentation protocol or other program to send data to a thin-client or remote-display application executing on the client to present display output generated by an application executing on the server 206. The thin-client or remote-display protocol can be any one of the following non-exhaustive list of protocols: the Independent Computing Architecture (ICA) protocol developed by Citrix Systems, Inc. of Ft. Lauderdale, Florida; or the Remote Desktop Protocol (RDP) manufactured by the Microsoft Corporation of Redmond, Washington.

A remote computing environment may include more than one server 206a-206n such that the servers 206a-206n are logically grouped together into a server farm 206, for example, in a cloud computing environment. The server farm 206 may include servers 206 that are geographically dispersed while logically grouped together, or servers 206 that are located proximate to each other while logically grouped together. Geographically dispersed servers 206a-206n within a server farm 206 can, in some embodiments, communicate using a WAN (wide), MAN (metropolitan), or LAN (local), where different geographic regions can be characterized as: different continents; different regions of a continent; different countries; different states; different cities; different campuses; different rooms; or any combination of the preceding geographical locations. In some embodiments the server farm 206 may be administered as a single entity, while in other embodiments the server farm 206 can include multiple server farms.

In some embodiments, a server farm may include servers 206 that execute a substantially similar type of operating system platform (e.g., WINDOWS, UNIX, LINUX, iOS, ANDROID, etc.) In other embodiments, server farm 206 may include a first group of one or more servers that execute a first type of operating system platform, and a second group of one or more servers that execute a second type of operating system platform.

Server 206 may be configured as any type of server, as needed, e.g., a file server, an application server, a web server, a proxy server, an appliance, a network appliance, a gateway, an application gateway, a gateway server, a virtualization server, a deployment server, a Secure Sockets Layer (SSL) VPN server, a firewall, a web server, an application server or as a master application server, a server executing an active directory, or a server executing an application acceleration program that provides firewall functionality, application functionality, or load balancing functionality. Other server types may also be used.

Some embodiments include a first server 206a that receives requests from a client machine 240, forwards the request to a second server 206b (not shown), and responds to the request generated by the client machine 240 with a response from the second server 206b (not shown.) First server 206a may acquire an enumeration of applications available to the client machine 240 as well as address information associated with an application server 206 hosting an application identified within the enumeration of applications. First server 206a can then present a response to the client's request using a web interface, and communicate directly with the client 240 to provide the client 240 with access to an identified application. One or more clients 240 and/or one or more servers 206 may transmit data over network 230, e.g., network 101.

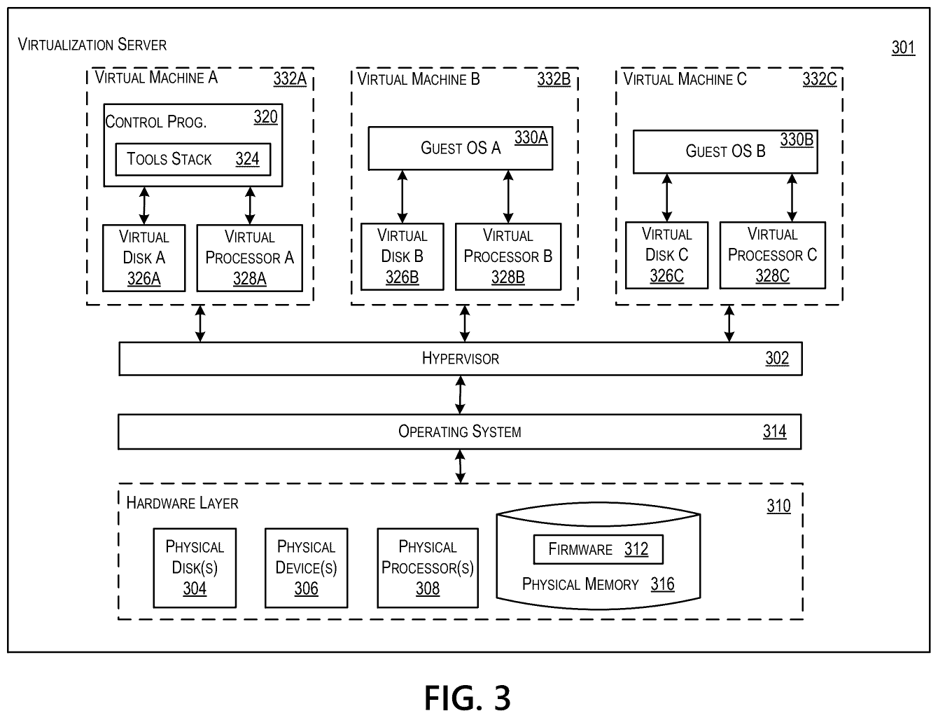

FIG. 3 shows a high-level architecture of an illustrative desktop virtualization system. As shown, the desktop virtualization system may be single-server or multi-server system, or cloud system, including at least one virtualization server 301 configured to provide virtual desktops and/or virtual applications to one or more client access devices 240. As used herein, a desktop refers to a graphical environment or space in which one or more applications may be hosted and/or executed. A desktop may include a graphical shell providing a user interface for an instance of an operating system in which local and/or remote applications can be integrated. Applications may include programs that execute after an instance of an operating system (and, optionally, also the desktop) has been loaded. Each instance of the operating system may be physical (e.g., one operating system per device) or virtual (e.g., many instances of an OS running on a single device). Each application may be executed on a local device, or executed on a remotely located device (e.g., remoted).

A computer device 301 may be configured as a virtualization server in a virtualization environment, for example, a single-server, multi-server, or cloud computing environment. Virtualization server 301 illustrated in FIG. 3 can be deployed as and/or implemented by one or more embodiments of the server 206 illustrated in FIG. 2 or by other known computing devices. Included in virtualization server 301 is a hardware layer that can include one or more physical disks 304, one or more physical devices 306, one or more physical processors 308, and one or more physical memories 316. In some embodiments, firmware 312 can be stored within a memory element in the physical memory 316 and can be executed by one or more of the physical processors 308. Virtualization server 301 may further include an operating system 314 that may be stored in a memory element in the physical memory 316 and executed by one or more of the physical processors 308. Still further, a hypervisor 302 may be stored in a memory element in the physical memory 316 and can be executed by one or more of the physical processors 308.

Executing on one or more of the physical processors 308 may be one or more virtual machines 332A-C (generally 332). Each virtual machine 332 may have a virtual disk 326A-C and a virtual processor 328A-C. In some embodiments, a first virtual machine 332A may execute, using a virtual processor 328A, a control program 320 that includes a tools stack 324. Control program 320 may be referred to as a control virtual machine, Dom0, Domain 0, or other virtual machine used for system administration and/or control. In some embodiments, one or more virtual machines 332B-C can execute, using a virtual processor 328B-C, a guest operating system 330A-B.

Virtualization server 301 may include a hardware layer 310 with one or more pieces of hardware that communicate with the virtualization server 301. In some embodiments, the hardware layer 310 can include one or more physical disks 304, one or more physical devices 306, one or more physical processors 308, and one or more physical memory 316. Physical components 304, 306, 308, and 316 may include, for example, any of the components described above. Physical devices 306 may include, for example, a network interface card, a video card, a keyboard, a mouse, an input device, a monitor, a display device, speakers, an optical drive, a storage device, a universal serial bus connection, a printer, a scanner, a network element (e.g., router, firewall, network address translator, load balancer, virtual private network (VPN) gateway, Dynamic Host Configuration Protocol (DHCP) router, etc.), or any device connected to or communicating with virtualization server 301. Physical memory 316 in the hardware layer 310 may include any type of memory. Physical memory 316 may store data, and in some embodiments may store one or more programs, or set of executable instructions. FIG. 3 illustrates an embodiment where firmware 312 is stored within the physical memory 316 of virtualization server 301. Programs or executable instructions stored in the physical memory 316 can be executed by the one or more processors 308 of virtualization server 301.

Virtualization server 301 may also include a hypervisor 302. In some embodiments, hypervisor 302 may be a program executed by processors 308 on virtualization server 301 to create and manage any number of virtual machines 332. Hypervisor 302 may be referred to as a virtual machine monitor, or platform virtualization software. In some embodiments, hypervisor 302 can be any combination of executable instructions and hardware that monitors virtual machines executing on a computing machine. Hypervisor 302 may be Type 2 hypervisor, where the hypervisor executes within an operating system 314 executing on the virtualization server 301. Virtual machines may then execute at a level above the hypervisor 302. In some embodiments, the Type 2 hypervisor may execute within the context of a user's operating system such that the Type 2 hypervisor interacts with the user's operating system. In other embodiments, one or more virtualization servers 301 in a virtualization environment may instead include a Type 1 hypervisor (not shown). A Type 1 hypervisor may execute on the virtualization server 301 by directly accessing the hardware and resources within the hardware layer 310. That is, while a Type 2 hypervisor 302 accesses system resources through a host operating system 314, as shown, a Type 1 hypervisor may directly access all system resources without the host operating system 314. A Type 1 hypervisor may execute directly on one or more physical processors 308 of virtualization server 301, and may include program data stored in the physical memory 316.

Hypervisor 302, in some embodiments, can provide virtual resources to operating systems 330 or control programs 320 executing on virtual machines 332 in any manner that simulates the operating systems 330 or control programs 320 having direct access to system resources. System resources can include, but are not limited to, physical devices 306, physical disks 304, physical processors 308, physical memory 316, and any other component included in hardware layer 310 of the virtualization server 301. Hypervisor 302 may be used to emulate virtual hardware, partition physical hardware, virtualize physical hardware, and/or execute virtual machines that provide access to computing environments. In still other embodiments, hypervisor 302 may control processor scheduling and memory partitioning for a virtual machine 332 executing on virtualization server 301. Hypervisor 302 may include those manufactured by VMWare, Inc., of Palo Alto, California; HyperV, VirtualServer or virtual PC hypervisors provided by Microsoft, or others. In some embodiments, virtualization server 301 may execute a hypervisor 302 that creates a virtual machine platform on which guest operating systems may execute. In these embodiments, the virtualization server 301 may be referred to as a host server. An example of such a virtualization server is the Citrix Hypervisor provided by Citrix Systems, Inc., of Fort Lauderdale, FL.

Hypervisor 302 may create one or more virtual machines 332B-C (generally 332) in which guest operating systems 330 execute. In some embodiments, hypervisor 302 may load a virtual machine image to create a virtual machine 332. In other embodiments, the hypervisor 302 may execute a guest operating system 330 within virtual machine 332. In still other embodiments, virtual machine 332 may execute guest operating system 330.

In addition to creating virtual machines 332, hypervisor 302 may control the execution of at least one virtual machine 332. In other embodiments, hypervisor 302 may present at least one virtual machine 332 with an abstraction of at least one hardware resource provided by the virtualization server 301 (e.g., any hardware resource available within the hardware layer 310). In other embodiments, hypervisor 302 may control the manner in which virtual machines 332 access physical processors 308 available in virtualization server 301. Controlling access to physical processors 308 may include determining whether a virtual machine 332 should have access to a processor 308, and how physical processor capabilities are presented to the virtual machine 332.

As shown in FIG. 3, virtualization server 301 may host or execute one or more virtual machines 332. A virtual machine 332 is a set of executable instructions that, when executed by a processor 308, may imitate the operation of a physical computer such that the virtual machine 332 can execute programs and processes much like a physical computing device. While FIG. 3 illustrates an embodiment where a virtualization server 301 hosts three virtual machines 332, in other embodiments virtualization server 301 can host any number of virtual machines 332. Hypervisor 302, in some embodiments, may provide each virtual machine 332 with a unique virtual view of the physical hardware, memory, processor, and other system resources available to that virtual machine 332. In some embodiments, the unique virtual view can be based on one or more of virtual machine permissions, application of a policy engine to one or more virtual machine identifiers, a user accessing a virtual machine, the applications executing on a virtual machine, networks accessed by a virtual machine, or any other desired criteria. For instance, hypervisor 302 may create one or more unsecure virtual machines 332 and one or more secure virtual machines 332. Unsecure virtual machines 332 may be prevented from accessing resources, hardware, memory locations, and programs that secure virtual machines 332 may be permitted to access. In other embodiments, hypervisor 302 may provide each virtual machine 332 with a substantially similar virtual view of the physical hardware, memory, processor, and other system resources available to the virtual machines 332.

Each virtual machine 332 may include a virtual disk 326A-C (generally 326) and a virtual processor 328A-C (generally 328.) The virtual disk 326, in some embodiments, is a virtualized view of one or more physical disks 304 of the virtualization server 301, or a portion of one or more physical disks 304 of the virtualization server 301. The virtualized view of the physical disks 304 can be generated, provided, and managed by the hypervisor 302. In some embodiments, hypervisor 302 provides each virtual machine 332 with a unique view of the physical disks 304. Thus, in these embodiments, the particular virtual disk 326 included in each virtual machine 332 can be unique when compared with the other virtual disks 326.

A virtual processor 328 can be a virtualized view of one or more physical processors 308 of the virtualization server 301. In some embodiments, the virtualized view of the physical processors 308 can be generated, provided, and managed by hypervisor 302. In some embodiments, virtual processor 328 has substantially all of the same characteristics of at least one physical processor 308. In other embodiments, virtual processor 308 provides a modified view of physical processors 308 such that at least some of the characteristics of the virtual processor 328 are different than the characteristics of the corresponding physical processor 308.

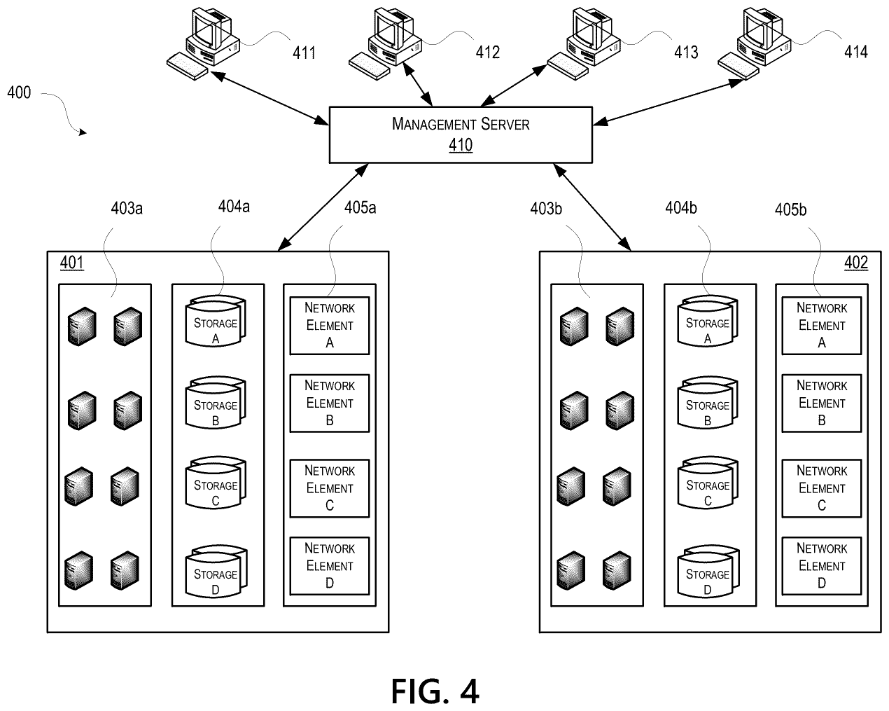

With further reference to FIG. 4, some aspects described herein may be implemented in a cloud-based environment. FIG. 4 illustrates an example of a cloud computing environment (or cloud system) 400. As seen in FIG. 4, client computers 411-414 may communicate with a cloud management server 410 to access the computing resources (e.g., host servers 403a-403b (generally referred herein as “host servers 403”), storage resources 404a-404b (generally referred herein as “storage resources 404”), and network elements 405a-405b (generally referred herein as “network resources 405”)) of the cloud system.

Management server 410 may be implemented on one or more physical servers. The management server 410 may run, for example, Citrix Cloud by Citrix Systems, Inc. of Ft. Lauderdale, FL, or OPENSTACK, among others. Management server 410 may manage various computing resources, including cloud hardware and software resources, for example, host computers 403, data storage devices 404, and networking devices 405. The cloud hardware and software resources may include private and/or public components. For example, a cloud may be configured as a private cloud to be used by one or more particular customers or client computers 411-414 and/or over a private network. In other embodiments, public clouds or hybrid public-private clouds may be used by other customers over an open or hybrid networks.

Management server 410 may be configured to provide user interfaces through which cloud operators and cloud customers may interact with the cloud system 400. For example, the management server 410 may provide a set of application programming interfaces (APIs) and/or one or more cloud operator console applications (e.g., web-based or standalone applications) with user interfaces to allow cloud operators to manage the cloud resources, configure the virtualization layer, manage customer accounts, and perform other cloud administration tasks. The management server 410 also may include a set of APIs and/or one or more customer console applications with user interfaces configured to receive cloud computing requests from end users via client computers 411-414, for example, requests to create, modify, or destroy virtual machines within the cloud. Client computers 411-414 may connect to management server 410 via the Internet or some other communication network, and may request access to one or more of the computing resources managed by management server 410. In response to client requests, the management server 410 may include a resource manager configured to select and provision physical resources in the hardware layer of the cloud system based on the client requests. For example, the management server 410 and additional components of the cloud system may be configured to provision, create, and manage virtual machines and their operating environments (e.g., hypervisors, storage resources, services offered by the network elements, etc.) for customers at client computers 411-414, over a network (e.g., the Internet), providing customers with computational resources, data storage services, networking capabilities, and computer platform and application support. Cloud systems also may be configured to provide various specific services, including security systems, development environments, user interfaces, and the like.

Certain clients 411-414 may be related, for example, to different client computers creating virtual machines on behalf of the same end user, or different users affiliated with the same company or organization. In other examples, certain clients 411-414 may be unrelated, such as users affiliated with different companies or organizations. For unrelated clients, information on the virtual machines or storage of any one user may be hidden from other users.

Referring now to the physical hardware layer of a cloud computing environment, availability zones 401-402 (or zones) may refer to a collocated set of physical computing resources. Zones may be geographically separated from other zones in the overall cloud of computing resources. For example, zone 401 may be a first cloud datacenter located in California, and zone 402 may be a second cloud datacenter located in Florida. Management server 410 may be located at one of the availability zones, or at a separate location. Each zone may include an internal network that interfaces with devices that are outside of the zone, such as the management server 410, through a gateway. End users of the cloud (e.g., clients 411-414) might or might not be aware of the distinctions between zones. For example, an end user may request the creation of a virtual machine having a specified amount of memory, processing power, and network capabilities. The management server 410 may respond to the user's request and may allocate the resources to create the virtual machine without the user knowing whether the virtual machine was created using resources from zone 401 or zone 402. In other examples, the cloud system may allow end users to request that virtual machines (or other cloud resources) are allocated in a specific zone or on specific resources 403-405 within a zone.

In this example, each zone 401-402 may include an arrangement of various physical hardware components (or computing resources) 403-405, for example, physical hosting resources (or processing resources), physical network resources, physical storage resources, switches, and additional hardware resources that may be used to provide cloud computing services to customers. The physical hosting resources in a cloud zone 401-402 may include one or more computer servers 403, such as the virtualization servers 301 described above, which may be configured to create and host virtual machine instances. The physical network resources in a cloud zone 401 or 402 may include one or more network elements 405 (e.g., network service providers) comprising hardware and/or software configured to provide a network service to cloud customers, such as firewalls, network address translators, load balancers, virtual private network (VPN) gateways, Dynamic Host Configuration Protocol (DHCP) routers, and the like. The storage resources in the cloud zone 401-402 may include storage disks (e.g., solid state drives (SSDs), magnetic hard disks, etc.) and other storage devices.

The example cloud computing environment shown in FIG. 4 also may include a virtualization layer (e.g., as shown in FIGS. 1-3) with additional hardware and/or software resources configured to create and manage virtual machines and provide other services to customers using the physical resources in the cloud. The virtualization layer may include hypervisors, as described above in FIG. 3, along with other components to provide network virtualizations, storage virtualizations, etc. The virtualization layer may be as a separate layer from the physical resource layer, or may share some or all of the same hardware and/or software resources with the physical resource layer. For example, the virtualization layer may include a hypervisor installed in each of the virtualization servers 403 with the physical computing resources. Known cloud systems may alternatively be used, e.g., WINDOWS AZURE (Microsoft Corporation of Redmond Washington), AMAZON EC2 (Amazon.com Inc. of Seattle, Washington), IBM BLUE CLOUD (IBM Corporation of Armonk, New York), or others.

### Providing Rapid Reconnection by Persisting Point-to-Point Connections

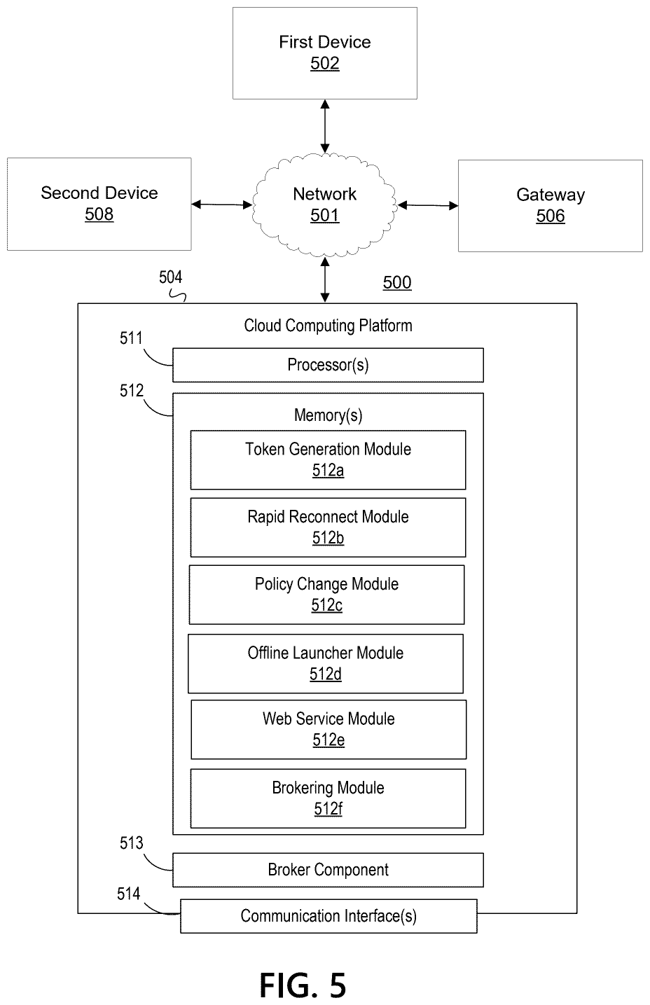

FIG. 5 depicts an illustrative computing environment for providing rapid reconnection by persisting point-to-point connections in accordance with one or more illustrative aspects described herein. Referring to FIG. 5, computing environment 500 may include one or more computer systems. For example, computing environment 500 may include a first device 502, a cloud computing platform 504, a gateway 506 and a second device 508.

As illustrated in greater detail below, first device 502 may be a personal computing device such as a smartphone, tablet, laptop computer, desktop computer, or the like. In some instances, first device 502 may be configured for management by a third party organization (e.g., using mobile device management), and may in some instances store enterprise, personal, and/or other data that is confidential or otherwise protected. In some instances, first device 502 may be configured to facilitate the use of virtual desktops, virtual applications, or the like. Although a single client device is depicted, any number of such devices may be implemented in the methods described herein without departing from the scope of the disclosure.

Cloud computing platform 504 may be a computer system that includes one or more computing devices (e.g., servers, server blades, smartphones, tablets, laptop computers, desktop computers, routers, or the like) and/or other computer components (e.g., processors, memories, communication interfaces). In some examples, the cloud computing platform 504 may comprise a plurality of different computing devices each configured to perform one or more functions to provide rapid reconnection by persisting point-to-point connections as described herein. For example, the cloud computing platform 504 may comprise a device (e.g., a server) configured for cloud computing, a gateway device (e.g., a router), and/or other devices configured to perform the functions described herein. In some examples, the cloud computing platform 504 may be configured to communicate with one or more devices and/or applications (e.g., license brokers, gateway devices (e.g., gateway 506, or the like), and/or other devices or applications) located and/or managed separately from the cloud computing platform 504 (e.g., in a client on-premises data center, and/or otherwise separate from the cloud computing platform 504) In some examples, cloud computing platform 504 may comprise one or more computer components (e.g., memories) storing modules, instructions, or the like configured to provide and/or interact with one or more websites and/or web-based services. In some examples, cloud computing platform 504 may comprise and/or correspond to a broker component 513. For example, the cloud computing platform 504 may include and/or be connected to a broker component such as a desktop delivery controller (DDC) configured to identify resource locations, negotiate licenses, and/or perform other functions related to hosting the one or more virtual desktops and/or other virtual applications.

Gateway 506 may be a device comprising one or more computers or computing components (e.g., routers, switches, servers, firewalls, and/or other devices and/or software). In one or more instances, the gateway 506 may be and/or comprise a physical device located at a on-premises data center corresponding to, for example, a client of an entity associated with the cloud computing platform 504 (e.g., the client corresponding to the first device 502). In other examples, the gateway 506 may be included in and/or otherwise associated with the cloud computing platform 504 without departing from the scope of this disclosure. The gateway 506 may be configured and/or designed to function as a point, node, gate, or the like between two or more additional devices (e.g., the first device 502 and the second device 508). In these examples, the gateway 506 may enable wireless data connections, network traffic flow, and/or other inter-device interactions between the two or more additional devices. For example, the gateway 506 may be and/or comprise a NetScaler Gateway device as designed by Citrix Systems, Inc. of Ft. Lauderdale, FL, and/or other gateway devices. The gateway 506 may restrict access to one or more resources. For example, the gateway 506 may restrict access to virtual desktops and/or virtual applications to devices (e.g., first device 502) that provide authentication information indicating an account, license, or the like allows the devices access to the virtual desktops and/or applications. The gateway 506 may facilitate communication between computing devices (e.g., first device 502 and second device 508) by functioning as an intermediary device, node, or the like in an end-to-end connection between the devices. For example, gateway 506 may comprise an intermediary point for establishing point-to-point connections between the first device 502 and the second device 508 to form an end-to-end connection between the first device 502 and second device 508.

Second device 508 may be a computer system that includes one or more computing devices (e.g., servers, server blades, or the like) and/or other computer components (e.g., processors, memories, communication interfaces). In one or more instances, second device 508 may be configured to host one or more virtual desktops and/or virtual applications and/or other virtual applications, and may be configured to communicate with one or more client devices (e.g., first device 502) to facilitate the use of such desktops and/or applications. Additionally or alternatively, in one or more examples, the second device 508 may be configured to host one or more services (e.g., voice over Internet protocol (VOIP) services, or the like).

Computing environment 500 may also include one or more networks, which may interconnect first device 502, cloud computing platform 504, and/or second device 508. For example, computing environment 500 may include a wired or wireless network 501 (which may e.g., interconnect first device 502, cloud computing platform 504, and second device 508).

In one or more arrangements, first device 502, cloud computing platform 504, second device 508, and/or the other systems included in the computing environment may be any type of computing device capable of receiving a user interface, receiving input via the user interface, and communicating the received input to one or more other computing devices. For example, first device 502, cloud computing platform 504, second device 508, and/or the other systems included in the computing environment may in some instances, be and/or include server computers, desktop computers, laptop computers, tablet computers, smart phones, or the like that may include one or more processors, memories, communication interfaces, storage devices, and/or other components. As noted above, and as illustrated in greater detail below, any and/or all of first device 502, cloud computing platform 504, and second device 508 may, in some instances, be special purpose computing devices configured to perform specific functions.

As described herein cloud computing platform 504 may comprise one or more computing devices and/or one or more computing components. For example, cloud computing platform 504 may include one or more processors 511, memory 512, broker component 513, and communication interface 514. A data bus may interconnect processor 511, memory 512, broker component 513, and communication interface 514. Communication interface 514 may be a network interface configured to support communication between the cloud computing platform 504 and one or more networks (e.g., network 501, or the like). Memory 512 may include one or more program modules having instructions that when executed by processor 511 cause cloud computing platform 504 to perform one or more functions described herein and/or access one or more databases that may store and/or otherwise maintain information which may be used by such program modules and/or processor 511.

In some instances, the one or more program modules and/or databases may be stored by and/or maintained in different memory units of cloud computing platform 504 and/or by different computing devices that may form and/or otherwise make up cloud computing platform 504. For example, memory 512 may have, host, store, and/or include instructions that direct and/or otherwise cause cloud computing platform 504 to facilitate rapid reconnection by persisting point-to-point connections. For example, the cloud computing platform 504 may store and/or otherwise include token generation module 512a, rapid reconnect module 512b, policy change module 512c, offline launcher module 512d, web service module 512c, brokering module 512f, and/or other modules. Token generation module 512a may facilitate an initial launch of remote and/or virtual desktop sessions based on requests received from the first device 502. For example, token generation module 512a may generate and maintain a reconnect token, generate authentication identifiers, generate session files, and/or perform other functions of an initial launch as described herein. Rapid reconnect module 512b may facilitate a rapid reconnection of an end-to-end connection. For example, rapid reconnect module 512b may utilize stored reconnect tokens, compare reconnect tokens and public keys, generate session files, reestablish severed point-to-point connections, and/or perform other functions of a rapid reconnection described herein. Policy change module 512c may facilitate implementing policy changes in persistent connections. For example, policy change module 512c may invalidate tokens, establish new point-to-point connections, update paused point-to-point connections, and/or perform other functions of implementing a policy change described herein. Offline launcher module 512d may facilitate rapid reconnection when cloud services are not available. For example, offline launcher module 512d may provide an offline launcher for client devices to connect to a virtual desktop without utilizing a cloud component of cloud computing platform 504 (e.g., without using a cloud-based workspace application, or the like). Web service module 512e may facilitate communications with and/or host one or more web-based services. For example, web service module 512e may be and/or communicate with an XML web service (e.g., a secure ticket authority, or the like) configured to provide services (e.g., authentication services, or the like) for systems implementing the methods of providing rapid reconnection by persisting point-to-point connections described herein. Brokering module 512f may facilitate negotiation of connection leases, licenses, or the like between client devices (e.g., first device 502) and servers hosting virtual desktops and/or applications (e.g., second device 508).

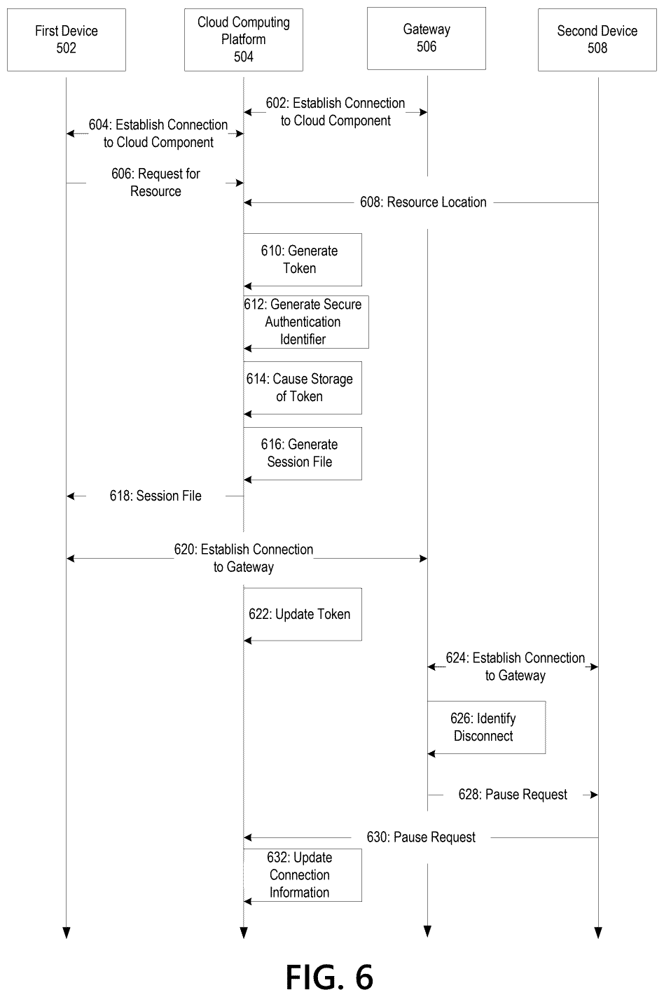

FIG. 6 depicts an illustrative event sequence for performing an initial launch as part of providing rapid reconnection by persisting point-to-point connections in accordance with one or more illustrative aspects described herein. Referring to FIG. 6, at step 602, a cloud component of the cloud computing platform 504 may establish a connection with the gateway 506. For example, if the gateway 506 is located in an on-premises datacenter, the cloud computing platform 504 may establish a wireless data connection with the gateway 506 at the datacenter (e.g., in order to use the gateway 506 as an intermediary point in an end-to-end connection). In some examples, the gateway 506 may be included in and/or otherwise associated with the cloud computing platform 504. In these examples, a connection may have previously been established between the cloud computing platform and the 506.

At step 604, a cloud component of the cloud computing platform 504 may establish a connection with the first device 502. For example, the first device 502 may send a request for a virtual desktop and/or other remote session to a cloud-based service (e.g., a workspace application, or the like) included in, hosted by, and/or otherwise corresponding to the cloud computing platform 504. The cloud computing platform 504 may establish, based on the request, the connection between the cloud component and the first device 502.

At step 606, the cloud computing platform 504 may receive a resource request. For example, the cloud computing platform 504 may receive (e.g., at the communication interface 514) a request for a resource sent by the first device 502 and while the connection between the cloud component of the cloud computing platform 504 and the first device 502 is established. In some examples, the resource request may comprise a request to launch a virtual resource, such as a virtual desktop and/or other remote session. In these examples, the functions performed at step 606 may be performed simultaneously or near-simultaneously with the functions performed at step 604. In some examples, the resource request may additionally comprise a request for one or more resources hosted and/or managed by a virtual desktop and/or a virtual application (e.g., files, applications, or the like) and accessible via a virtual desktop and/or other remote session. Additionally or alternatively, in some examples, the resource request may comprise authentication information corresponding to the first device 502. For example, the resource request may comprise a client identification (e.g., a number, code, or the like) corresponding to a user of the first device 502, a client public key corresponding to the first device 502, and/or other authentication information. In these examples, the cloud component of the cloud computing platform 504 may store the authentication information (e.g., to memory 512, and/or other memory).

At step 608, the cloud computing platform 504 may retrieve a resource location from the second device 508. For example, the cloud computing platform 504 may send/transmit a message to the second device 508 (e.g., via communication interface 514, and/or by other methods) requesting that the second device 508 respond with a message identifying the location (e.g., a directory, storage location, or the like) of the resource requested by the first device 502. Based on sending/transmitting the message, the cloud computing platform 504 may receive, from the second device 508, an indication of the location of the resource.

At step 610, the cloud computing platform 504 may generate a reconnect token. For example, the cloud computing platform 504 may generate a reconnect token configured to initiate a rapid reconnection between the first device 502 and a device hosting a virtual desktop and/or a virtual application and/or other remote session (e.g., second device 508). In some examples, the cloud computing platform 504 may generate the reconnect token based on user authentication information received from the first device 502. For example, the cloud computing platform 504 may generate a reconnect token comprising a public key corresponding to the first device 502, a username of a user corresponding to the first device 502, a client identifier corresponding to the first device 502, and/or other identification or authentication information corresponding to the first device 502. In some examples, the reconnect token may comprise a context identifier (e.g., a universally unique identifier (UUID), or the like), an indicator of a resource corresponding to the resource request, for example, a resource name (e.g., the name of a virtual desktop and/or application, the name of a file, or the like) a resource identifier (e.g., identification information corresponding to a device, such as second device 508, associated with the resource), and/or other indicators of a resource, an indicator of a validity period (e.g., a date of expiration of the reconnect token, or the like), and/or other information. Also or alternatively, in some examples, the reconnect token may comprise the location of the resource. For example, the reconnect token may comprise the indicator of the storage location of the resource received at step 608. In some examples, in generating the reconnect token, the cloud computing platform 504 may generate a digital representation of the information described herein. In some examples, in generating the reconnect token, the cloud computing platform 504 may store the reconnect token (e.g., at and/or with the cloud computing component).

At step 612, based on receiving the resource location, the cloud computing platform 504 may generate a secure authentication identifier for the reconnect token. For example, the cloud computing platform 504 may generate a secure ticket authority (STA) identifier configured to identify the reconnect token (e.g., amongst a plurality of other reconnect tokens that may, in some examples, be stored together). In some examples, in generating the secure authentication identifier, the cloud computing platform 504 may request that one or more web-based services generate a unique identifier for the reconnect token. For example, the cloud computing platform 504 may, through the web service module 512e and/or based on instructions from the web service module 512e, communicate with a server hosting and/or maintaining a secure authentication component (e.g., an STA). For example, the cloud computing platform 504 may receive instructions from the web service module 512e directing and/or otherwise causing the cloud computing platform 504 to access a server hosting and/or maintaining a secure authentication component configured to randomly generate a ticket corresponding to input information (e.g., the reconnect token, and/or information corresponding to the reconnect token). In these examples, in generating the secure authentication identifier for the reconnect token, the cloud computing platform 504 may cause and/or request the STA service to generate a random series of numbers (e.g., a random ticket) for the reconnect token. In some examples, the server hosting and/or maintaining the STA may be a device, application, or the like included in the components comprising cloud computing platform 504. In some arrangements, the server hosting and/or maintaining the STA may be a separate device, application, or the like unaffiliated with the cloud computing platform 504. In some examples, in generating the secure authentication identifier for the reconnect token, the cloud computing platform 504 may receive the secure authentication identifier (e.g., a randomly generated ticket) from the STA service.

At step 614, the cloud computing platform 504 may cause storage of the reconnect token. For example, the cloud computing platform 504 may cause storage of the reconnect token at the STA (e.g., at a server hosting the STA). In some examples, the cloud computing platform 504 may comprise the STA and, in these examples, may store the reconnect token to memory (e.g., memory 512, or the like).

At step 616, the cloud computing platform 504 may generate a session file. For example, the cloud computing platform 504 may generate a session file for a connection between the first device 502 and the second device 508 (e.g., via the gateway 506) in preparation for establishing such a connection. In some examples, in generating the session file, the cloud computing platform 504 may generate a file configured to establish a connection between devices using a particular protocol, such as the ICA protocol. The session file may comprise an indicator of the reconnect token. For example, the session file may comprise the UUID of the reconnect token, the secure authentication identifier, and/or other identifiers. The session file may additionally comprise information required to establish the connection between the first device 502 and the gateway 506 and/or information required to establish the connection between the gateway 506 and the second device 508 (e.g., the location of a resource, such as virtual application and/or virtual desktop).

At step 618, based on generating the session file, the cloud computing platform 504 may send the session file to the first device 502. For example, the cloud computing platform 504 may send the session file via the communication interface 514 and/or while the connection to the cloud computing component is established. In some examples, sending the session file may cause the first device 502 to cache and/or otherwise store the session file for use in providing rapid reconnection as described herein.

At step 620, based on the cloud computing platform 504 sending the session file to the first device 502, the gateway 506 may establish a connection between the first device 502 and a gateway. For example, the gateway 506 may establish a connection between the first device 502 and gateway 506 using information from the session file provided to the first device 502 by the cloud computing platform 504. Accordingly, the cloud computing platform 504 may cause and/or otherwise facilitate the connection between the first device 502 and the gateway 506 by sending the session file as described at step 618. In establishing the connection between the first device 502 and gateway 506, the gateway 506 may receive, from the first device 502, authentication information. For example, gateway 506 may receive the reconnect token UUID, the secure authentication identifier (e.g., an STA identifier, or the like), and/or other authentication information from the first device 502 in order to authenticate the first device 502. In some examples, the first device 502 may initially send the authentication information to the cloud computing platform 504. In these examples, the gateway 506 may receive the authentication information from the cloud computing platform 504.

In some examples, in establishing the connection between the first device 502 and the gateway, the gateway 506 may, based on receiving the authentication information, request an STA ticket from the STA. For example, the gateway 506 may request, from the cloud computing platform 504 and based on the secure authentication identifier, a corresponding STA ticket from the server and/or application hosting and/or maintaining the STA (e.g., through the web service module 512e). In these examples, gateway 506 may receive the STA ticket from the cloud computing platform 504 via the server and/or application hosting and/or maintaining the STA and validate the STA ticket prior to establishing the connection between the first device 502 and the gateway 506.

At step 622, the cloud computing platform 504 may update the reconnect token. In some examples, the cloud computing platform 504 may update the reconnect token based on information corresponding to a connection between the second device 508 and the gateway 506. For example, the cloud computing platform 504 may update the reconnect token by adding, to the reconnect token, an indicator of a fully qualified domain name (FQDN) corresponding to the second device 508 and/or the gateway 506. In some examples, in updating the reconnect token, the cloud computing platform 504 and/or the gateway 506 may request the FQDN from the server and/or application hosting and/or maintaining the STA (e.g., through the web service module 512e). In some examples, the functions of step 622 may be performed simultaneously or near-simultaneously with the functions of step 624 described herein.

At step 624, the gateway 506 may establish a connection between the second device 508 and the gateway 506. In some examples, in establishing the connection between the second device 508 and the gateway 506, the second device 508 may connect to a node of the gateway 506. Establishing the connection between the second device 508 and gateway 506 may establish an ICA connection and/or other types of end-to-end connection between the first device 502 and the second device 508 (e.g., via the connection between the first device 502 and the gateway 506, and the connection between the second device 508 and the gateway 506).

At step 626, based on establishing an end-to-end connection between the first device 502 and the second device 508 (e.g., comprising the connection between the first device 502 and the gateway 506 and the connection between the second device 508 and the gateway 506), the gateway 506 may identify a disconnect. For example, the gateway 506 may identify whether a dropped connection, severed connection, invalidation of a connection and/or other types of disconnect occurred between the first device 502 and the gateway 506, disabling and/or invalidating the connection between the first device 502 and the gateway 506. In some examples, in identifying the disconnect, the gateway 506 may identify the disconnect based on one or more trigger parameters (e.g., predetermined parameters indicating that disconnect has occurred or is likely to occur). The one or more trigger parameters may comprise one or more of: identifying a change in protocol corresponding to the connection between the first device 502 and the gateway 506, identifying a change in protocol corresponding to the connection between the second device 508 and the gateway 506, identifying a change in an Internet protocol (IP) address corresponding to the first device 502, identifying that the first device 502 has moved to a geographical location outside of a threshold range of the connection between the first device 502 and the gateway 506, identifying that a network disruption has occurred for a threshold amount of time, and/or other trigger parameters. For example, the gateway 506 may identify that a user of the first device 502 has moved the first device 502 to another location, that a user has placed the first device 502 in a sleep mode and/or otherwise deactivated the first device 502, and/or other indicators that one or more trigger parameters have been satisfied. In some examples, at least a portion of the information used to identify the disconnect may be provided to the gateway 506 by the cloud computing platform 504 without departing from the scope of this disclosure. Also or alternatively, in some examples, the gateway 506 may send and/or otherwise provide an indication, notification, or the like identifying that the connection between the first device 502 and the gateway 506 was disconnected to the cloud computing platform 504.

In some examples, the second device 508 may correspond to a VOIP service. In these examples, in identifying a disconnect, the gateway 506 may identify a change in a protocol corresponding to the first device 502. For example, the gateway 506 may identify a change in IP address corresponding to the first device 502. The change in protocol may cause the connection between the first device 502 and the gateway 506 to be disconnected. Additionally or alternatively, in identifying a disconnect, the gateway 506 may identify a network switch. For example, a network corresponding to the first device 502 may change from a Wi-Fi network to a 5G network. In these examples, the network change may cause the connection between the first device 502 and the gateway 506 to be disconnected.

At step 628, based on the gateway 506 identifying a disconnect (e.g., based on identifying that the one or more trigger parameters have been satisfied), the gateway 506 may pause the connection between the second device 508 and the gateway 506. For example, the gateway 506 may send a pause request, notification, message, or the like to the second device 508 requesting that the connection between the second device 508 and gateway 506 be paused. Pausing the connection between the second device 508 and the gateway 506 may persist the connection, allowing the end-to-end connection between the first device 502 and the second device 508 to be reconnected (by, and/or with the assistance of, the cloud computing platform 504) without first reestablishing the connection between the second device 508 and the gateway 506. In some examples, in pausing the connection between the second device 508 and the gateway 506, the gateway 506 may indicate a threshold period of time the connection between the second device 508 and the gateway 506 will remain paused (e.g., persist) before a resume request, as described herein, is received.

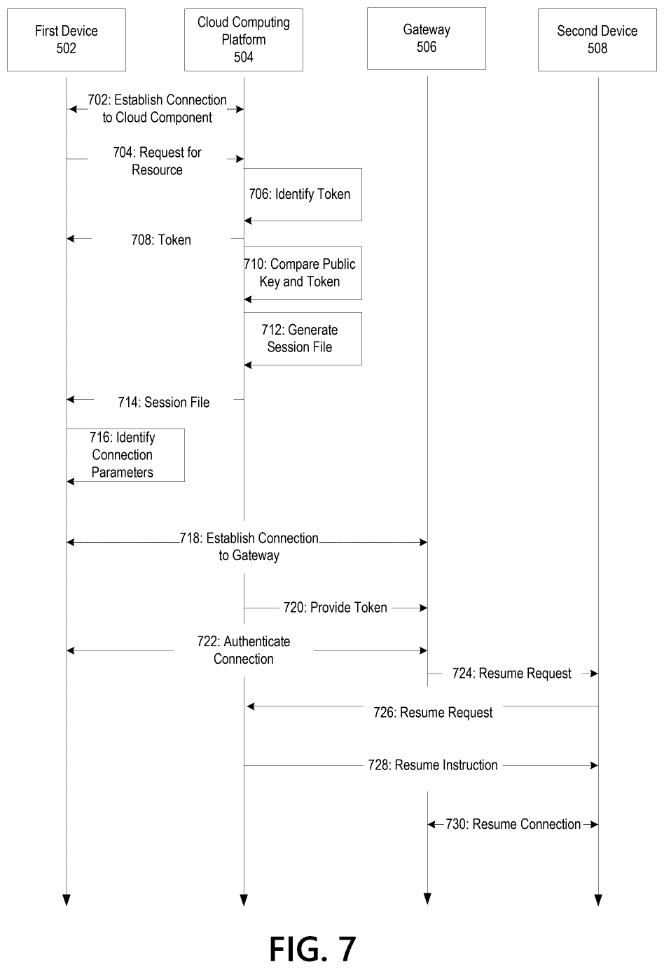

At step 630, the cloud computing platform 504 may receive a pause request and/or an indication of a pause request from the second device 508. For example, based on pausing the connection between the gateway 506 and the second device 508 as described at step 628, the second device 508 may notify the cloud computing platform 504 that the connection between the gateway 506 and the second device 508 is paused. In these examples, the second device 508 may send the pause request and/or indication of the pause request to the broker component 513 to prompt the cloud computing platform 504 to, via the broker component 513, perform one or more actions required to maintain the paused connection in an up-to-date state (e.g., as described further at step 632). The pause request and/or indication of the pause request may instruct the cloud computing platform 504 to maintain information required to resume the connection between the gateway 506 and the second device 508 until a resume request is received (e.g., as described further herein with respect to FIG. 7).

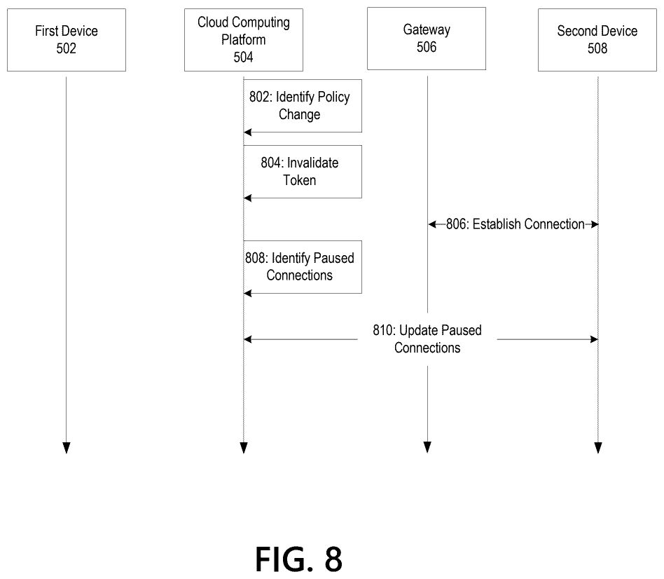

At step 632, the cloud computing platform 504 may update connection information. For example, the cloud computing platform 504 may update connection information corresponding to the paused connection between the gateway 506 and the second device 508, the disconnected connection between the gateway 506 and the first device 502, and/or the end-to-end connection between the first device 502 and the second device 508. In updating the connection information, the cloud computing platform 504 may cause the broker component 513 to update the connection information based on the pause request and/or indication of the pause request received by the broker component 513. For example, the cloud computing platform 504 may cause the broker component 513 to broker the connection between the second device 508 and the gateway 506, update and/or review licensing information between the first device 502 and the second device 508, implement one or more policy changes corresponding to the first device 502, the second device 508, and/or the cloud computing platform 504, and/or perform other actions. The cloud computing platform 504 may cause the broker component 513 to store a new session state. For example, the cloud computing platform 504 may cause the broker component to store a pause session state corresponding to the paused connection between the gateway 506 and the second device 508 (e.g., for use in resuming the paused connection at a later time). The cloud computing platform 504 may implement policy changes as described further herein with respect to FIG. 8. The cloud computing platform 504 may update licensing information between the first device 502 and the second device 508 based on information indicating that the client device 502 no longer possesses a license to access the virtual desktops and/or virtual applications hosted by the second device 508. In these examples, the cloud computing platform 504 may cause the paused connection between the gateway 506 and the second device 508 to be invalidated, disconnected, and/or otherwise ended. It should be understood that the examples described herein are merely illustrative and that the cloud computing platform 504 and/or the broker component 513 may perform additional or alternative brokering functions without departing from the scope of this disclosure.

FIG. 7 depicts an illustrative event sequence for reestablishing a connection as part of providing rapid reconnection by persisting point-to-point connections in accordance with one or more illustrative aspects described herein. For example, the functions described with respect to FIG. 7 at steps 702-730 may be performed based on or in response to identifying a disconnect, pausing a connection, and/or updating connection information as described with respect to FIG. 6. Referring to FIG. 7, at step 702, a cloud component of the cloud computing platform 504 may establish a connection with the first device 502. For example, the first device 502 may send a request for a virtual desktop and/or other remote session to a cloud-based service (e.g., a workspace application, or the like) included in, hosted by, and/or otherwise corresponding to the cloud computing platform 504. For example, the first device 502 may send a request to establish a session where a persistent connection is maintained between the gateway 506 and the second device 508 based on a previous request for a virtual desktop (e.g., as described herein with respect to FIG. 6 at steps 602-606). The cloud computing platform 504 may establish, based on the request, the connection between the cloud component and the first device 502.

At step 704, the cloud computing platform 504 may receive a resource request. For example, the cloud computing platform 504 may receive (e.g., at the communication interface 514) a request for a resource sent by the first device 502 and while the connection between the cloud component of the cloud computing platform 504 and the first device 502 is established. In some examples, the resource request may comprise a request to launch a virtual resource, such as a virtual desktop and/or other remote session. For example, the resource request may comprise a request to relaunch, restore, and/or otherwise reestablish the connection between the first device 502 and a virtual desktop and/or application that was previously established during performance of the functions recited with respect to FIG. 6 herein. In these examples, the functions performed at step 704 may be performed simultaneously or near-simultaneously with the functions performed at step 702. In some examples, the resource request may additionally comprise a request for one or more resources hosted and/or managed by a virtual desktop and/or application (e.g., files, applications, or the like) and accessible via a virtual desktop and/or other remote session. Additionally or alternatively, in some examples, the resource request may comprise authentication information corresponding to the first device 502 and/or a previous end-to-end connection between the first device 502 and the second device 508. For example, the resource request may comprise a client identification (e.g., a number, code, or the like) corresponding to a user of the first device 502, a client public key corresponding to the first device 502, an indicator of a reconnect token corresponding to the first device 502 (e.g., a UUID of a reconnect token), and/or other authentication information. In these examples, the cloud component of the cloud computing platform 504 may store the authentication information (e.g., to memory 512, and/or other memory).

At step 706, the cloud computing platform 504 may identify a reconnect token. For example, the cloud computing platform 504 may identify a reconnect token generated during an initial launch and corresponding to a previous end-to-end connection between the first device 502 and the second device 508. In identifying the reconnect token, the cloud computing platform 504 may query, through the web service module 512e and/or based on instructions from the web service module 512e, a server hosting and/or maintaining a secure authentication component (e.g., an STA). For example, the cloud computing platform 504 may query an XML web service (e.g., an STA service, as described herein) with a user identification (e.g., the client identification corresponding to the user received at step 704, or the like) and an indicator of the reconnect token (e.g., the UUID of the reconnect token). Based on querying secure authentication component, the cloud computing platform 504 may identify a storage location of the cloud computing platform 504 at a server hosting and/or maintaining the secure authentication component (e.g., an STA server, as described herein) and retrieve, from the server, the reconnect token. The reconnect token may be the updated reconnect token described herein with respect to FIG. 6 at step 622.

At step 708, the cloud computing platform 504 may send (e.g., via the communication interface 514) the UUID of the reconnect token and the FQDN indicated by the reconnect token to the first device 502. In some examples, sending the UUID of the reconnect token and the FQDN to the first device 502 may cause the first device 502 to supplement a cached session file (e.g., a cached ICA file). For example, the first device 502 may add, to the cached session file, some or all of the information included in the reconnect token.

At step 710, the cloud computing platform 504 may compare a public key to the reconnect token. For example, the cloud computing platform 504 may compare a public key received at step 704 to the reconnect token to identify whether the public key matches a public key corresponding to the reconnect token. By comparing the public key to the reconnect token, the cloud computing platform 504 may determine whether the first device 502 is the same device that previously established the end-to-end connection indicated by the reconnect token based on identifying whether the public key matches a public key corresponding to the reconnect token. In some examples, based on identifying that the public key does match the public key corresponding to the reconnect token, functions described below at steps 712-714 may not be performed. In some examples, based on identifying that the public key does not match the public key corresponding to the reconnect token, the cloud computing platform 504 may proceed to step 712 and generate a session file.

At step 712, based on identifying that the public key does not match the public key corresponding to the reconnect token, the cloud computing platform 504 may generate a session file. In some examples, in generating a session file, the cloud computing platform 504 may update the reconnect token. For example, the cloud computing platform 504 may update the reconnect token by adding, to the reconnect token, the public key received at step 704. In some examples, in generating the session file, the cloud computing platform 504 may generate a session file for a connection between the first device 502 and the gateway 506 (e.g., in preparation for establishing such a connection). In some examples, in generating the session file, the cloud computing platform 504 may generate a file configured to establish a connection between devices using a particular protocol, such as the ICA protocol. The session file may comprise an indicator of the reconnect token. For example, the session file may comprise the UUID of the reconnect token, the secure authentication identifier, and/or other identifiers. The session file may additionally comprise information required to establish the connection between the first device 502 and the gateway 506.

At step 714, based on generating the session file, the cloud computing platform 504 may send the session file to the first device 502. For example, the cloud computing platform 504 may send the session file via the communication interface 514 and/or while the connection to the cloud computing component is established. In some examples, sending the session file may cause the first device 502 to cache the session file for use in providing rapid reconnection as described herein.

At step 716, based on receiving the session file from the cloud computing platform 504, the first device 502 may identify connection parameters. For example, the first device 502 may identify connection parameters for establishing a connection between the first device 502 and a gateway (e.g., as part of reestablishing an end-to-end connection between the first device 502 and cloud computing platform 504). In some examples, in identifying the connection parameters, the first device 502 may identify a FQDN corresponding to the gateway 506 and/or to the second device 508, a connection protocol, and/or other parameters. In identifying the connection parameters, the first device 502 may, in some examples, extract the connection parameters from a session file received from the cloud computing platform 504 (e.g., as described at steps 712-714). In other examples, in identifying the connection parameters, the first device 502 may reconstruct a session file (e.g., a session file corresponding to a disconnected end-to-end connection). In reconstructing the session file, the first device 502 may retrieve, generate, and/or otherwise reconstruct a session file based on a cached session identified by an indicator of the reconnect token. For example, the first device 502 may reconstruct the session file based on identifying parameters of a previous ICA session corresponding to the UUID of the reconnect token.

At step 718, based on identifying the connection parameters and/or reconstructing the session file, the gateway 506 may establish a connection between the first device 502 and the gateway 506. For example, the gateway 506 may establish, or reestablish, a connection between the first device 502 and the gateway 506 in preparation for reconnecting an end-to-end connection between the first device 502 and the second device 508. By establishing or reestablishing the connection between the first device 502 and the gateway 506, the gateway 506 may facilitate rapid reconnection of the first device 502 and the second device 508 by providing a point-to-point connection to connect and/or otherwise link the first device 502 to the second device 508 via a persistent point-to-point connection between the gateway 506 and the second device 508. In some examples, in establishing the connection between the first device 502 and the gateway 506, the gateway 506 may cause the first device 502 to resolve a FQDN identified by the first device 502 at step 716. In some examples, in establishing the connection between the first device 502 and the gateway, the gateway 506 may reestablish a VOIP media connection between the first device 502 and the gateway 506.

At step 720, based on the connection between the first device 502 and the gateway 506, the cloud computing platform 504 may provide the reconnect token to the gateway 506. For example, based on a request from the gateway 506, the cloud computing platform 504 may query the secure authentication component (e.g., the STA and/or STA server) to retrieve the reconnect token. In some examples, in retrieving the reconnect token, the cloud computing platform 504 may retrieve the reconnect token corresponding to the connection between the first device 502 and the gateway 506 based on the secure authentication identifier previously generated for the reconnect token (e.g., as described herein with respect to FIG. 6 at step 612). For example, the cloud computing platform 504 may retrieve the reconnect token for the gateway 506 based on receiving a request including the UUID of the reconnect token.

At step 722, the gateway 506 may authenticate the connection between the first device 502 and the gateway 506. For example, the gateway 506 may authenticate the connection between the first device 502 and the gateway 506 prior to resuming the connection between the gateway 506 and the second device 508 to provide security benefits, such as ensuring an unauthorized user is not attempting to access a persisting connection. In some examples, in authenticating the connection between the first device 502 and the gateway 506, the gateway 506 may generate a challenge query for the first device 502 (which may, e.g., be based on the reconnect token). In some examples, the challenge query may comprise a number used once (nonce) cryptographic challenge. In some examples, the nonce may correspond to the reconnect token. In authenticating the connection between the first device 502 and the gateway 506, the gateway 506 may send the challenge query to the first device 502. Based on receiving a signature from the first device 502 matching a private key, the gateway 506 may confirm authentication of the connection between the first device 502 and the gateway 506.

At step 724, based on the gateway 506 authenticating the connection between the first device 502 and the gateway 506, the gateway 506 may send a resume request to the second device 508. For example, the gateway 506 may send a message, notification, or the like to the second device 508 instructing the second device 508 to resume a paused connection between the second device 508 and the gateway 506.

At step 726, the cloud computing platform 504 may receive a resume request from the second device 508. For example, the cloud computing platform 504 may receive a message, signal, instruction, or the like directing the cloud computing platform 504 to resume a connection between the gateway 506 and the second device 508. In some examples, the cloud computing platform 504 may receive a resume request corresponding to a paused connection (e.g., a connection paused based on performing the functions recited at steps 602-632, as described herein). In some examples, the resume request may be and/or comprise the resume request sent by the gateway 506 to the second device 508 at step 724. For example, based on receiving the resume request from the gateway 506, the second device 508 may forward the resume request to the cloud computing platform 504.

At step 728, the cloud computing platform 504 may send a resume instruction to the second device 508. In some examples, the cloud computing platform 504 may send the resume instruction based on brokering the connection between the gateway 506 and the second device 508 using the broker component 513. For example, the broker component 513 may use a session state (e.g., a resume session sate) to broker the connection and ensure that the connection being resumed between the gateway 506 and the second device 508 corresponds to the connection between the first device 502 and the gateway 506. The resume instruction may comprise an indication that the connection between the gateway 506 and the second device 508 should be resumed, or an indication that the connection between the gateway 506 and the second device 508 should not be resumed. The resume instruction may be based on one or more actions, performed by the cloud computing platform 504, designed to determine whether the connection between the gateway 506 and the second device 508 should be resumed. For example, in sending the resume instruction to the second device 508, the cloud computing platform 504 may first ensure that a user associated with the first device 502 has access to the resource, confirm whether a license corresponding to the resource is available for the first device 502 to consume, confirm that no policy changes prevent or restrict a connection between the first device 502 and the second device 508, perform load balancing to confirm that the second device 508 will not experience an overload based on resuming the connection, and/or perform other actions to determine whether the connection between the gateway 506 and the second device 508 should be resumed. In some examples, the resume request received by the cloud computing platform 504 at step 726 may comprise one or more instructions directing the cloud computing platform 504 to perform the one or more actions confirming whether the connection between the 506 and the 508 should be resumed.

Based on confirming that the connection between the gateway 506 and the second device 508 should be resumed, the cloud computing platform 504 may send a resume instruction indicating that the connection should be resumed and proceed to step 730. Based on confirming that the connection between the gateway 506 and the second device 508 should not be resumed, the cloud computing platform 504 may send a resume instruction indicating that the connection should not be resumed and invalidating the paused connection between the gateway 506 and the second device 508.

At step 730, based on the cloud computing platform 504 sending/transmitting a resume instruction indicating that the connection between the second device 508 and the gateway 506 should be resumed, the second device 508 may resume a connection between the gateway 506 and the second device 508. For example, the second device 508 may resume a connection between the gateway 506 and the second device 508 that was previously paused based on identifying a disconnect (e.g., as described herein with respect to FIG. 6 at steps 626-630). In some examples, based on resuming the connection between the gateway 506 and the second device 508, the first device 502, cloud computing platform 504, gateway 506, and second device 508 may complete the process of providing the rapid reconnection by persisting point-to-point connections as described herein. By performing the functions recited with respect to FIG. 7 at steps 702-730, a rapid reconnect may be achieved in significantly less time (e.g., approximately twice as fast, in some examples) than conventional methods of reconnecting involving re-establishing multiple connections between a first device and a second device via an intermediate gateway. Accordingly, the functions recited herein provide improvements to efficiency and user experience for systems associated with virtual desktops and/or virtual applications and/or other remote sessions. In some examples, in resuming the connection between the second device 508 and the gateway 506, the second device 508 may reestablish a VoIP media connection between the second device 508 and the gateway 506 (e.g., using VoIP protocols corresponding to a previously-disconnected connection between the first device 502 and the second device 508).

FIG. 8 depicts an illustrative event sequence for implementing policy changes as part of providing rapid reconnection by persisting point-to-point connections in accordance with one or more illustrative aspects described herein. Referring to FIG. 8, at step 802, the cloud computing platform 504 may identify a policy change. For example, the cloud computing platform 504 may receive, from the second device 508 and/or a component of the cloud computing platform (e.g., broker component 513, and/or other components), an indication of a policy change corresponding to the connection between the first device 502 and the gateway 506 and/or the connection between the second device 508 and the gateway 506. In identifying the policy change, the cloud computing platform 504 may identify one or more parameters for implementing the policy change. For example, the cloud computing platform 504 may identify whether implementing the policy change requires invalidating a reconnect token. Based on identifying a policy change that does not require invalidating a reconnect token (e.g., a policy change that does not prevent the first device 502 from connecting to the second device 508, and/or other policy changes), the cloud computing platform 504 may proceed to step 808 without performing the functions recited at steps 804-806. Based on identifying a policy change that requires invalidating a reconnect token (e.g., a policy change indicating that the first device 502 is not authorized to connect to the second device 508 any longer, and/or other policy changes), the cloud computing platform 504 may proceed to step 804 and invalidate the policy.

At step 804, based on identifying a policy change that requires invalidating a reconnect token, the cloud computing platform 504 may invalidate a reconnect token. For example, the cloud computing platform 504 may send, to the secure authentication component (e.g., an STA server and/or application, as described herein), a message to invalidate the reconnect token corresponding to a persisting point-to-point connection between the second device 508 and the gateway. In some examples, based on invalidating the reconnect token, the cloud computing platform 504 may additionally sever and/or otherwise disconnect the connection between the second device 508 and the gateway 506. In other examples, the cloud computing platform 504 may not sever and/or otherwise disconnect the connection between the second device 508 and the gateway 506. In these examples, the cloud computing platform 504 may establish a rapid reconnect (e.g., as described at steps 702-730 herein) prior to performing a policy evaluation (e.g., as described at step 802). In these examples, the cloud computing platform 504 may perform authentication (e.g., a handshake) between the first device 502 and the second device 508 rather than performing the resume request as described at steps 724-730. In these examples, the cloud computing platform 504 may reestablish the connection, based on the policy evaluation, without performing the functions recited at steps 806-808.

In some examples, based on invalidating the reconnect token, the cloud computing platform 504 may perform one or more steps of establishing a new initial connection between the first device 502 and the second device 508 (e.g., via the gateway 506). For example, the cloud computing platform 504 may perform some or all of the functions described at steps 602-632 herein to generate a new session file, a new reconnect token and/or UUID, and/or perform other functions required to establish an initial connection between the first device 502 and the second device 508.

At step 806, based on the cloud computing platform 504 invalidating the reconnect token, the gateway 506 may establish a new connection between the second device 508 and the gateway 506. In some examples, in establishing the new connection between the second device 508 and the gateway 506, the second device 508 may connect to a node of the gateway 506. Establishing the new connection between the second device 508 and gateway 506 may establish an ICA connection and/or other types of end-to-end connection between the first device 502 and the second device 508 (e.g., via the connection between the first device 502 and the gateway 506, and the connection between the second device 508 and the gateway 506). Based on the new connection between the second device 508 and the gateway 506, the cloud computing platform 504 may persist the new connection between the second device 508 and the gateway 506 without performing the functions recited at steps 808-810.

At step 808, based on identifying a policy change that does not require invalidating a reconnect token, the cloud computing platform 504 may identify paused connections. For example, the cloud computing platform 504 may identify persisting point-to-point connections between devices hosting services (e.g., second device 508, or the like) and gateways (e.g., gateway 506, or the like). In some examples, in identifying the paused connections, the cloud computing platform 504 may identify a plurality of devices other than and/or in addition to the second device 508 affected by the policy change. For example, the cloud computing platform 504 may identify additional virtual desktops and/or virtual application servers maintaining persistent connections with gateway 506 and/or other gateways.

At step 810, based on identifying the paused connections, the cloud computing platform 504 may update one or more paused connections. For example, the cloud computing platform 504 may apply the policy change to the devices corresponding to each of the one or more paused connections and/or to the one or more paused connections themselves. In some examples, in updating the one or more paused connections, the cloud computing platform 504 may update and/or generate instructions, protocols, rulesets, or the like configured to notify the cloud computing platform 504 that, upon resuming an end-to-end connection (e.g., as described with respect to FIG. 7 at steps 724-730), and ICA handshake should be performed to implement the policy change. In these examples, the cloud computing platform 504 may cause a new ICA initialization sequence to begin (e.g., by sending an initialization request to the first device 502, and/or by other methods), implementing the policy change, as the one or more paused connections are resumed.

In some examples, the functions described herein with respect to FIG. 8 may be performed during performance of one or more functions described herein with respect to FIGS. 6 and 7. For example, the functions described herein at steps 802-810 may be performed at any time while an end-to-end connection between first device 502 and second device 508 is established. For example, the functions described at steps 802-810 may be performed after establishing a connection between the second device 508 and the gateway 506, prior to identifying a disconnect as described at step 626.

In some instances, the methods described above with regard to steps 602-632, steps 702-730, and/or steps 802-810 may be applied to any remote connection solution (virtual applications, remote desktops, virtual network computing, secure shell, and/or other solutions), remote browser execution scenario, or the like without departing from the scope of the disclosure to provide rapid reconnection by persisting point-to-point connections.

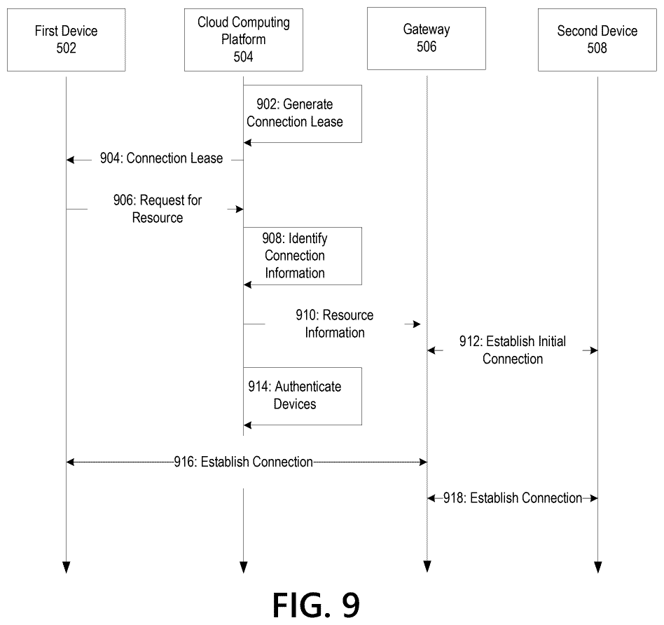

It should be understood that, in some examples, cloud-based services (e.g., services corresponding to the cloud component of the cloud computing platform 504) may not be available (e.g., in the event of a service outage). In these examples, rapid reconnects by persisting point-to-point connections may be achieved by first performing an offline launch. For example, based on a workspace application and/or an STA being rendered unavailable, the cloud computing platform 504 may perform an offline launch using a prelaunch protocol (e.g., a Connection Lease Exchange and Mutual Trust Protocol (CLXMTP) developed by Citrix Systems, Inc. of Ft. Lauderdale, Florida) designed to facilitate connection or reconnection when one or more cloud services are unavailable. The cloud computing platform 504 may, based on performing the offline launch, establish an end-to-end connection using a protocol (e.g., ICA) and/or perform a rapid reconnect as described herein. FIG. 9 depicts an illustrative event sequence for performing an offline launch in accordance with one or more illustrative aspects as described herein.

Referring to FIG. 9, at step 902, the cloud computing platform 504 may generate one or more connection leases. For example, the cloud computing platform 504 may generate one or more connection leases that each correspond to one or more resources (e.g., resources located at the second device 508 and/or other devices). In some examples, a connection lease may include a plurality of component connection leases that each correspond to a different resource. In some examples, a connection lease may correspond to a single resource. Each connection lease may include information required to establish a connection between a user device (e.g., first device 502, or the like), an intermediate gateway (e.g., gateway 506), and one or more additional devices (e.g., second device 508, or the like). For example, a connection lease may comprise information identifying the location of a resource, security information for connecting to an intermediate gateway (e.g., permissions, passwords, encryption keys, or the like), instructions for connecting to the intermediate gateway, instructions for connecting to a device hosting a resource (e.g., second device 508, or the like), and/or other information required to establish an end-to-end connection via an intermediate gateway.

At step 904, the cloud computing platform 504 may send/transmit the one or more connection leases to the first device 502. For example, the cloud computing platform 504 may send the one or more connection leases via a wireless data connection between the cloud computing platform 504 and the first device 502. In some examples, based on sending/transmitting the one or more connection leases to the first device 502, the cloud computing platform 504 may cause the first device 502 to store the one or more connection leases (e.g., for use in performing offline reconnects as described herein).

At step 906, the cloud computing platform 504 may receive a resource request. For example, the cloud computing platform 504 may receive (e.g., at the communication interface 514) a request for a resource sent by the first device 502 and while the connection between the cloud computing platform 504 and the first device 502 is established. In some examples, the resource request may comprise a request to launch a virtual resource, such as a virtual desktop and/or other remote session. The resource request may comprise a connection lease corresponding to the requested resource and providing instructions or information identifying the location of a resource, security information for connecting to an intermediate gateway (e.g., permissions, passwords, encryption keys, or the like), instructions for connecting to the intermediate gateway, instructions for connecting to a device hosting a resource (e.g., second device 508, or the like), and/or other information required to establish an end-to-end connection via an intermediate gateway.

At step 908, the cloud computing platform 504 may identify connection information. For example, the cloud computing platform 504 may analyze, read, parse, and/or otherwise use the connection lease, included in the resource request, to identify connection information required to connect the first device 502 to the requested resource at the second device 508. In some examples, the cloud computing platform 504 may identify connection information using the broker component 513. For example, the broker component 513 may identify an optimal device (e.g., second device 508) hosting the requested resource. For example, the broker component 513 may identify that the second device 508 corresponds to a license associated with a user of the first device 502 and, as a result, the cloud computing platform 504 may identify the second device 508 as the device to which the first device 502 must be connected. In some examples, the broker component 513 may be offline. In these examples, the cloud computing platform 504 may identify, based on the connection lease, a list of devices corresponding to the requested resource. In these examples, the cloud computing platform 504 may attempt to connect the first device 502 to each device on the list until a successful connection is achieved.

At step 910, based on identifying the connection information, the cloud computing platform 504 may provide resource information to the gateway 506. For example, the cloud computing platform 504 may provide information indicating the device storing the requested resource (e.g., second device 508) and/or instructions directing the gateway 506 to establish a connection with the device storing the requested resource. In providing the resource information to the gateway 506, the cloud computing platform 504 may utilize a prelaunch protocol, such as the CLXMTP protocol.

At step 912, the gateway 506 may establish a connection between the gateway 506 and the second device 508 using a first protocol. For example, the gateway 506 may establish the connection using a prelaunch protocol such as the CLXMTP protocol. In some examples, the gateway 506 may establish the connection directly with the second device 508. Also or alternatively, in some examples, the gateway 506 may establish the connection to the second device 508 via one or more additional connection point (e.g., a server, a node, or the like) intermediary to the gateway 506 and the second device 508.

At step 914, based on the connection using the first protocol, the cloud computing platform 504 may authenticate one or more devices. For example, the cloud computing platform 504 may authenticate connections by using the prelaunch protocol the establish mutual trust between the first device 502 and the gateway 506 and/or between the gateway 506 and the second device 508. In some examples, the cloud computing platform 504 may establish mutual trust by causing the gateway 506 to perform one or more challenge/response actions. For example, the cloud computing platform 504 may cause the gateway 506 to challenge ownership of a private key by requiring the first device 502 to sign a nonce and/or other proof of ownership of the private key, establishing trust between the first device 502 and the gateway 506.

At step 916, based on the cloud computing platform 504 facilitating authentication of the first device 502 and the gateway 506, the gateway 506 may establish a connection between the gateway 506 and the first device 502 using a second protocol. For example, the gateway 506 may establish the connection between the gateway 506 and the first device 502 using the ICA protocol and/or other protocols.

At step 918, based on gateway 506 establishing the connection between the gateway 506 and the first device 502 and based on the connection lease, the gateway 506 may establish a connection with the second device 508 using the second protocol. For example, the gateway 506 may establish the connection between the gateway 506 and the second device 508 using the ICA protocol and/or other protocols. In some examples, in establishing the connection between the gateway 506 and the second device 508 using the second protocol, the gateway 506 may disconnect the connection between the gateway 506 and the second device 508 established using the first protocol. For example, the cloud computing platform 504 may sever and/or otherwise disconnect a connection between the cloud computing platform 504 and the second device 508 established using the CLXMTP protocol. In some examples, based on the connection between the gateway 506 and the second device 508, an initial end-to-end connection between the first device 502 and the second device 508 may be completed. The first device 502, the cloud computing platform 504, the gateway 506, and the second device 508 may subsequently perform some or all of the functions recited with respect to FIGS. 6, 7, and 8 as described herein in order to provide a rapid reconnect after establishing the offline connection described above at steps 902-918.

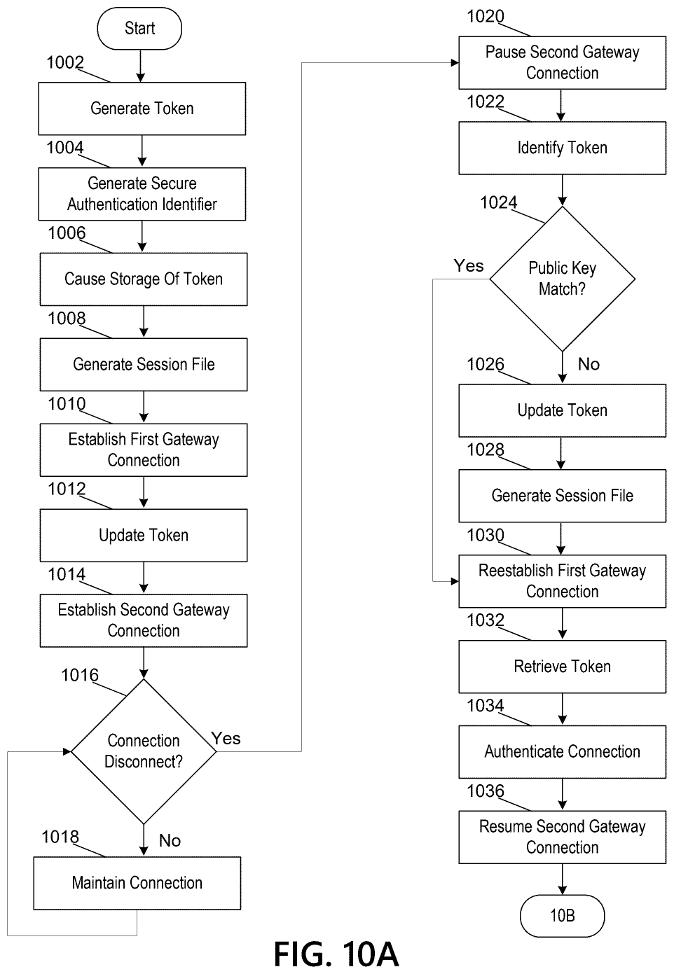

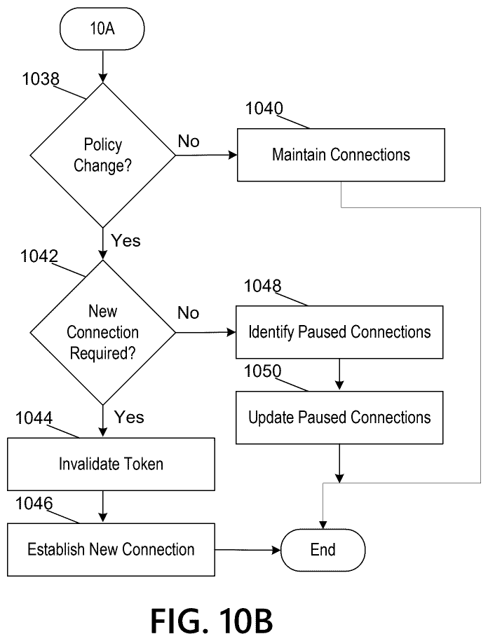

FIGS. 10A-10B depict illustrative methods for providing rapid reconnection by persisting point-to-point connections in accordance with one or more illustrative aspects described herein. For convenience, steps 1002-1050 are shown across FIGS. 10A-10B. However, it should be understood that steps 1002-1050 represent a single method (e.g., step 1038 in FIG. 10B may follow step 1036 in FIG. 10A). Referring to FIG. 10A, at step 1002, a computing device comprising one or more processors, a communication interface, and memory may generate a token (e.g., a reconnect token). At step 1004, the computing device may generate a secure authentication identifier corresponding to the token. At step 1006, the computing device may cause storage of the token (e.g., at a secure ticket authority, or the like). At step 1008, the computing device may generate a session file. At step 1010, the computing device may facilitate establishment of a first gateway connection. For example, a connection may be established between a first device (e.g., a client device) and a gateway. At step 1012, the computing device may update the token. For example, the computing device may update the token by adding a FQDN to the token. At step 1014, the computing device may facilitate establishment of a second gateway connection. For example, a connection between a second device providing a service (e.g., a virtual desktop and/or application server, a VoIP server, or the like) and the gateway may be established. At step 1016, the computing device may identify whether a disconnect has occurred. For example, the computing device may receive an indication that a disconnect occurred from the gateway. Based on identifying a disconnect, the computing device may proceed to step 1020. Based on identifying that no disconnect has occurred, the computing device may proceed to step 1018.

At step 1018, based on identifying that no disconnect has occurred, the computing device may maintain a connection. For example, the computing device may maintain information required to reconnect an end-to-end connection comprising the first gateway connection and the second gateway connection. Based on maintaining the connection, the computing device may return to step 1016. At step 1020, based on identifying that a disconnect has occurred, the computing device may facilitate pausing (e.g., by the gateway) of the second gateway connection. At step 1022, the computing device may identify a token. For example, the computing device may identify a token corresponding to the second gateway connection. At step 1024, the computing device may determine whether a public key matches the token. For example, the computing device may identify whether a public key corresponding to a first device (e.g., a client device) matches a public key included in the token. Based on determining that the public key matches the token, the computing device may proceed to step 1030. Based on determining that the public key does not match the token, the computing device may proceed to step 1026. At step 1026, based on determining that the public key does not match the token, the computing device may update the token. For example, the computing device may add, to the token, an indicator of the public key. At step 1028, the computing device may generate a session file. At step 1030, the computing device may facilitate reestablishment of the first gateway connection. At step 1032, the computing device may retrieve the token. For example, the computing device may retrieve the token from a secure ticket authority, or the like. At step 1034, the computing device may authenticate the first gateway connection. At step 1036, the computing device may resume the second gateway connection.

Referring to FIG. 10B, at step 1038, the computing device may identify whether a policy change has occurred. Based on identifying a policy change, the computing device may proceed to step 1042. Based on identifying that no policy change has occurred, the computing device may proceed to step 1040. At step 1040, based on identifying that no policy change has occurred, the computing device may maintain the first gateway connection and the second gateway connection. At step 1042, based on identifying a policy change, the computing device may identify whether a new connection is required to implement the policy. Based on identifying that a new connection is required to implement the policy, the computing device may proceed to step 1044. Based on identifying that a new connection is not required, the computing device may proceed to step 1048. At step 1044, based on identifying that a new connection is required, the computing device may invalidate the token. At step 1046, the computing device may establish a new connection. At step 1048, based on identifying that a new connection is not required, the computing device may identify paused connections. At step 1050, the computing device may update the paused connections.

The following paragraphs (M1) through (M14) describe examples of methods that may be implemented in accordance with the present disclosure.

(M1) A method comprising receiving, from a first device, a resource request; generating, based on user authentication information, a reconnect token for initiating a reconnect between the first device and a second device; generating a session file for a connection between the first device and a gateway, wherein the session file comprises an indicator of the reconnect token; updating, based on information of a connection between the second device and the gateway, the reconnect token; identifying, based on one or more trigger parameters, a disconnect between the first device and the gateway; pausing the connection between the second device and the gateway; reestablishing, based on the reconnect token, the connection between the first device and the gateway; and resuming, based on reestablishing the connection between the first device and the gateway, the connection between the second device and the gateway.

(M2) A method may be performed as described in paragraph (M1) wherein the reconnect token comprises: an identifier corresponding to the session file; an indicator of a resource corresponding to the resource request; identification information corresponding to the first device and to the second device; and an indicator of a validity period for the reconnect token.

(M3) A method may be performed as described in any of paragraphs (M1) through (M2) further comprising generating, at a secure authentication component separate from the first device, a secure authentication identifier for the reconnect token; and storing, at the secure authentication component, the reconnect token, wherein reestablishing the connection between the first device and the gateway comprises retrieving, from the secure authentication component and based on the secure authentication identifier, the reconnect token.

(M4) A method may be performed as described in any of paragraphs (M1) through (M3) wherein reestablishing the connection between the first device and the gateway comprises: reconstructing, based on the indicator of the reconnect token, the session file; resolving, based on the reconnect token, a domain name corresponding to the gateway; and connecting, based on the indicator of the reconnect token, the first device and the gateway.

(M5) A method may be performed as described in any of paragraphs (M1) through (M4) further comprising receiving, from the first device, the user authentication information, wherein the user authentication information comprises a public key; storing the public key, wherein reestablishing the connection between the first device and the gateway comprises authenticating, based on the stored public key, the first device; and retrieving, based on authenticating the first device, the reconnect token.

(M6) A method may be performed as described in any one of paragraphs (M1) through (M5) wherein updating the reconnect token comprises adding, to the reconnect token, a fully-qualified domain name.

(M7) A method may be performed as described in any one of paragraphs (M1) through (M6) wherein the gateway restricts access to a plurality of resources affiliated with the second device.

(M8) A method may be performed as described in any one of paragraphs (M1) through (M7) further comprising: generating, based on the reconnect token, a challenge query for the first device; and authenticating, based on the challenge query and prior to resuming the connection between the second device and the gateway, the connection between the first device and the gateway.

(M9) A method may be performed as described in any one of paragraphs (M1) through (M8) further comprising: identifying a policy change corresponding to the connection between the second device and the gateway; invalidating, based on the policy change, the reconnect token; and establishing, based on invalidating the reconnect token, a new connection between the second device and the gateway.

(M10) A method may be performed as described in any one of paragraphs (M1) through (M9) further comprising: identifying a policy change corresponding to the connection between the second device and the gateway; identifying a plurality of additional devices associated with the second device and affected by the policy change; and updating, based on resuming the connection between the gateway and the second device, the plurality of additional devices and the second device.

(M11) A method may be performed as described in any one of paragraphs (M1) through (M10) further comprising: identifying a change in a protocol corresponding to the first device, wherein identifying the disconnect between the first device and the gateway comprises identifying, based on the change in the protocol corresponding to the first device, a change in an Internet Protocol (IP) address corresponding to the first device, and wherein reestablishing the connection between the first device and the gateway comprises reestablishing the connection using protocols corresponding to the connection between the first device and the gateway.

(M12) A method may be performed as described in any one of paragraphs (M1) through (M11) wherein the one or more trigger parameters comprise one or more of: identifying a change in an IP address corresponding to the first device, identifying a change in a protocol corresponding to the connection between the first device and the gateway, or identifying a change in a protocol corresponding to the connection between the gateway and the second device.

(M13) A method may be performed as described in any one of paragraphs (M1) through (M12) further comprising: reestablishing, based on the reconnect token, one or more additional connections corresponding to the connection between the first device and the second device, wherein the one or more additional connections comprise at least one of: a connection to a device intermediary to the first device and the gateway, or a connection to a device intermediary to the second device and the gateway.

(M14) A method may be performed as described in any one of paragraphs (M1) through (M13) further comprising: identifying, after pausing the connection between the second device and the gateway, whether a license corresponding to the first device and a resource associated with the second device is active, wherein the resuming is further based on identifying that the license is active.

The following paragraphs (A1) through (A5) describe examples of apparatuses that may be implemented in accordance with the present disclosure.

(A1) A computing system comprising one or more processors; and memory storing computer executable instructions that, when executed by the one or more processors, cause the computing system to: receive, from a first device, a resource request; generate, based on user authentication information, a reconnect token for initiating a reconnect between the first device and a second device; generate a session file for a connection between the first device and a gateway, wherein the session file comprises an indicator of the reconnect token; update, based on information of a connection between the second device and the gateway, the reconnect token; identify, based on one or more trigger parameters, a disconnect between the first device and the gateway; identify a pause in the connection between the second device and the gateway; reestablish, based on the reconnect token, the connection between the first device and the gateway; and resume, based on reestablishing the connection between the first device and the gateway, the connection between the second device and the gateway.

(A2) A computing system as described in paragraph (A1), wherein the one or more trigger parameters comprise one or more of: identifying a change in an IP address corresponding to the first device, identifying a change in a protocol corresponding to the connection between the first device and the gateway, or identifying a change in a protocol corresponding to the connection between the gateway and the second device.

(A3) A computing system as described in any one of paragraphs (A1) through (A2), wherein the memory stores additional computer executable instructions that, when executed by the one or more processors, cause the computing system to: generate, at a secure authentication component separate from the first device, a secure authentication identifier for the reconnect token; and store, at the secure authentication component, the reconnect token, wherein reestablishing the connection between the first device and the gateway comprises retrieving, from the secure authentication component and based on the secure authentication identifier, the reconnect token.

(A4) A computing system as described in any one of paragraphs (A1) through (A3), wherein the memory stores additional computer executable instructions that, when executed by the one or more processors, cause the computing system to: receive, from the first device, the user authentication information, wherein the user authentication information comprises a public key; store the public key, wherein reestablishing the connection between the first device and the gateway comprises authenticating, based on the stored public key, the first device; and retrieve, based on authenticating the first device, the reconnect token.

(A5) A computing system as described in any one of paragraphs (A1) through (A4), wherein the memory stores additional computer executable instructions that, when executed by the one or more processors, cause the computing system to: identifying a policy change corresponding to the connection between the second device and the gateway; invalidating, based on the policy change, the reconnect token; and establishing, based on invalidating the reconnect token, a new connection between the second device and the gateway.

The following paragraph (CRM1) describes an example of computer-readable media that may be implemented in accordance with the present disclosure.

(CRM1) One or more non-transitory computer-readable media storing instructions that, when executed by a computing system comprising at least one processor, a communication interface, and memory, cause the computing system to: receive, from a first device, a resource request; generate, based on user authentication information, a reconnect token for initiating a reconnect between the first device and a second device; generate a session file for a connection between the first device and a gateway, wherein the session file comprises an indicator of the reconnect token; update, based on information of a connection between the second device and the gateway, the reconnect token; identify, based on one or more trigger parameters, a disconnect between the first device and the gateway; pause the connection between the second device and the gateway; reestablish, based on the reconnect token, the connection between the first device and the gateway; and resume, based on reestablishing the connection between the first device and the gateway, the connection between the second device and the gateway.

Although the subject matter has been described in language specific to structural features and/or methodological acts, it is to be understood that the subject matter defined in the appended claims is not necessarily limited to the specific features or acts described above. Rather, the specific features and acts described above are described as example implementations of the following claims.

What is claimed is:

1. A method comprising:
receiving, from a first device, a resource request;
generating, based on user authentication information, a reconnect token for initiating a reconnect between the first device and a second device;
generating a session file for a connection between the first device and a gateway, wherein the session file comprises an indicator of the reconnect token;
updating, based on information of a connection between the second device and the gateway, the reconnect token;
identifying, based on one or more trigger parameters, a disconnect between the first device and the gateway;
pausing the connection between the second device and the gateway;
reestablishing, based on the reconnect token, the connection between the first device and the gateway; and
resuming, based on reestablishing the connection between the first device and the gateway, the connection between the second device and the gateway.

2. The method of claim 1, wherein the reconnect token comprises:
an identifier corresponding to the session file;
an indicator of a resource corresponding to the resource request;
identification information corresponding to the first device and to the second device; and
an indicator of a validity period for the reconnect token.

3. The method of claim 1, further comprising:
generating, at a secure authentication component separate from the first device, a secure authentication identifier for the reconnect token; and
storing, at the secure authentication component, the reconnect token,
wherein reestablishing the connection between the first device and the gateway comprises retrieving, from the secure authentication component and based on the secure authentication identifier, the reconnect token.

4. The method of claim 1, wherein reestablishing the connection between the first device and the gateway comprises:
reconstructing, based on the indicator of the reconnect token, the session file;
resolving, based on the reconnect token, a domain name corresponding to the gateway; and
connecting, based on the indicator of the reconnect token, the first device and the gateway.

5. The method of claim 1, further comprising:
receiving, from the first device, the user authentication information, wherein the user authentication information comprises a public key;
storing the public key,
wherein reestablishing the connection between the first device and the gateway comprises authenticating, based on the stored public key, the first device; and
retrieving, based on authenticating the first device, the reconnect token.

6. The method of claim 1, wherein updating the reconnect token comprises adding, to the reconnect token, a fully-qualified domain name.

7. The method of claim 1, wherein the gateway restricts access to a plurality of resources affiliated with the second device.

8. The method of claim 1, further comprising:
generating, based on the reconnect token, a challenge query for the first device; and
authenticating, based on the challenge query and prior to resuming the connection between the second device and the gateway, the connection between the first device and the gateway.

9. The method of claim 1, further comprising:
identifying a policy change corresponding to the connection between the second device and the gateway;
invalidating, based on the policy change, the reconnect token; and
establishing, based on invalidating the reconnect token, a new connection between the second device and the gateway.

10. The method of claim 1, further comprising:
identifying a policy change corresponding to the connection between the second device and the gateway;
identifying a plurality of additional devices associated with the second device and affected by the policy change; and
updating, based on resuming the connection between the gateway and the second device, the plurality of additional devices and the second device.

11. The method of claim 1, further comprising:
identifying a change in a protocol corresponding to the first device,
wherein identifying the disconnect between the first device and the gateway comprises identifying, based on the change in the protocol corresponding to the first device, a change in an Internet Protocol (IP) address corresponding to the first device, and
wherein reestablishing the connection between the first device and the gateway comprises reestablishing the connection using protocols corresponding to the connection between the first device and the gateway.

12. The method of claim 1, wherein the one or more trigger parameters comprise one or more of:
identifying a change in an IP address corresponding to the first device,
identifying a change in a protocol corresponding to the connection between the first device and the gateway, or
identifying a change in a protocol corresponding to the connection between the gateway and the second device.

13. The method of claim 1, further comprising:
reestablishing, based on the reconnect token, one or more additional connections corresponding to the connection between the first device and the second device,
wherein the one or more additional connections comprise at least one of:
a connection to a device intermediary to the first device and the gateway, or
a connection to a device intermediary to the second device and the gateway.

14. The method of claim 1, further comprising:
identifying, after pausing the connection between the second device and the gateway, whether a license corresponding to the first device and a resource associated with the second device is active,
wherein the resuming is further based on identifying that the license is active.

15. A computing system comprising:
one or more processors; and
memory storing computer executable instructions that, when executed by the one or more processors, cause the computing system to:
receive, from a first device, a resource request;
generate, based on user authentication information, a reconnect token for initiating a reconnect between the first device and a second device;
generate a session file for a connection between the first device and a gateway, wherein the session file comprises an indicator of the reconnect token;
update, based on information of a connection between the second device and the gateway, the reconnect token;
identify, based on one or more trigger parameters, a disconnect between the first device and the gateway;
identify a pause in the connection between the second device and the gateway;
reestablish, based on the reconnect token, the connection between the first device and the gateway; and
resume, based on reestablishing the connection between the first device and the gateway, the connection between the second device and the gateway.

16. The computing system of claim 15, wherein the reconnect token comprises:
an identifier corresponding to the session file;
an indicator of a resource corresponding to the resource request;
identification information corresponding to the first device and to the second device; and
an indicator of a validity period for the reconnect token.

17. The computing system of claim 15, wherein the memory stores additional computer executable instructions that, when executed by the one or more processors, cause the computing system to:
generate, at a secure authentication component separate from the first device, a secure authentication identifier for the reconnect token; and
store, at the secure authentication component, the reconnect token,
wherein reestablishing the connection between the first device and the gateway comprises retrieving, from the secure authentication component and based on the secure authentication identifier, the reconnect token.

18. The computing system of claim 15, wherein the memory stores additional computer executable instructions that, when executed by the one or more processors, cause the computing system to:
receive, from the first device, the user authentication information, wherein the user authentication information comprises a public key;
store the public key,
wherein reestablishing the connection between the first device and the gateway comprises authenticating, based on the stored public key, the first device; and
retrieve, based on authenticating the first device, the reconnect token.

19. The computing system of claim 15, wherein the memory stores additional computer executable instructions that, when executed by the one or more processors, cause the computing system to:
identifying a policy change corresponding to the connection between the second device and the gateway;
invalidating, based on the policy change, the reconnect token; and
establishing, based on invalidating the reconnect token, a new connection between the second device and the gateway.

20. One or more non-transitory computer-readable media storing instructions that, when executed by a computing system comprising at least one processor, a communication interface, and memory, cause the computing system to:
receive, from a first device, a resource request;
generate, based on user authentication information, a reconnect token for initiating a reconnect between the first device and a second device;
generate a session file for a connection between the first device and a gateway, wherein the session file comprises an indicator of the reconnect token;
update, based on information of a connection between the second device and the gateway, the reconnect token;
identify, based on one or more trigger parameters, a disconnect between the first device and the gateway;
pause the connection between the second device and the gateway;
reestablish, based on the reconnect token, the connection between the first device and the gateway; and
resume, based on reestablishing the connection between the first device and the gateway, the connection between the second device and the gateway.
